(19) United States
(12) Patent Application Publication
(10) Pub. No.: US 2023/0084376 A1
(43) Pub. Date: Mar. 16, 2023

(54) INFORMATION PROCESSING DEVICE, 3D MODEL GENERATION METHOD, AND PROGRAM

(71) Applicant: SONY GROUP CORPORATION, Tokyo (JP)

(72) Inventor: Nobuaki IZUMI, Kanagawa (JP)

(73) Assignee: SONY GROUP CORPORATION, Tokyo (JP)

(21) Appl. No.: 17/801,403

(22) PCT Filed: Mar. 16, 2021
(86) PCT No.: PCT/JP2021/010470

§ 371 Date: Aug. 22, 2022

(30) Foreign Application Priority Data
Mar. 26, 2020 (JP) 2020-056899

(51) Int. Cl. G06T 17/20; G06T 7/40; G06T 7/50; G06T 7/62; G06V 10/74

(52) U.S. Cl. CPC G06T 17/20; G06T 7/40; G06T 7/50; G06T 7/62; G06V 10/761

(57) ABSTRACT

A first-layer depth map generation unit (131) (distance acquisition unit) of an encoding device (40a) (information processing device) acquires a first distance (d1) between a projecting point (Q) and a first point (P1) at which a straight line extending from the projecting point (Q) to a subject (90) comes into contact with the subject (90), on the basis of a 3D shape of a surface of the subject (90). Furthermore, on the basis of the 3D shape of the surface of the subject (90), a second-layer depth map generation unit (132) (distance acquisition unit) acquires a second distance (d2) between the projecting point (Q) and a second point (P2) from which the straight line extending through the inside of the subject (90) from the first point (P1) passes to the outside of the subject (90).

### FIELD

The present disclosure relates to an information processing device, a 3D model generation method, and a program.

### BACKGROUND

Conventionally, there has been proposed a method of generating a 3D object in a viewing space by using information obtained by sensing a real 3D space, for example, by using a multi-view video obtained by imaging a subject from different viewpoints, for generation of a video (volumetric video) in which the object looks as if the object is positioned in the viewing space.

The generation of the volumetric video requires coordinate information about a three-dimensional space. For example, in Patent Literature 1, a 3D shape of a subject is obtained on the basis of a depth map indicating a distance from a camera to a surface of the subject.

### CITATION LIST

### Patent Literature

Patent Literature 1: WO 2018/074252 A

### SUMMARY

### Technical Problem

However, in Patent Literature 1, a front surface of the subject facing the camera, that is, the 3D shape on the front surface side of the subject could only be obtained. Therefore, it is necessary to obtain a 3D shape of the back surface side of the subject on the basis of the depth map captured from the back surface side of the subject.

Therefore, there is a problem that it is difficult to generate an accurate shape of the subject.

The present disclosure proposes an information processing device, a 3D model generation method, and a program that are configured to generate an accurate shape of a subject.

### Solution to Problem

To solve the problems described above, an information processing device according to an embodiment of the present disclosure includes: a distance acquisition unit that acquires, based on a 3D shape of a surface of a subject, a first distance between a projecting point and a first point at which a straight line extending from the projecting point to the subject comes into contact with the subject, and a second distance between the projecting point and a second point from which the straight line extending through the inside of the subject from the first point passes to the outside of the subject.

### BRIEF DESCRIPTION OF DRAWINGS

FIG. 1 is a block diagram illustrating a schematic configuration of an information processing system according to a first embodiment.

FIG. 2 is a diagram illustrating an example of imaging devices.

FIG. 3 is a flowchart illustrating an example of a process performed by the information processing system.

FIG. 4 is a hardware block diagram illustrating an example of a hardware configuration of the information processing system.

FIG. 5 is a functional block diagram illustrating an example of a functional configuration of an encoding unit.

FIG. 6 is a diagram illustrating a method of generating depth maps.

FIG. 7 is a diagram illustrating quantized depth values of a first-layer depth map and a second-layer depth map.

FIG. 8 is a diagram illustrating an example of the first-layer depth map and the second-layer depth map.

FIG. 9 is a diagram illustrating an example of an image generated by a tiling unit.

FIG. 10 is a functional block diagram illustrating an example of a functional configuration of a decoding unit.

FIG. 11 is a diagram illustrating a method of reading a depth value from each of the depth maps by a depth valid area determination unit.

FIG. 12 is a diagram illustrating a method of determining validity/invalidity of the depth value by the depth valid area determination unit.

FIG. 13 is a flowchart illustrating an example of a process performed by the depth valid area determination unit.

FIG. 14 is a diagram illustrating triangular patches set on each depth map.

FIG. 15 is a diagram illustrating the number of valid points of the respective triangular patches.

FIG. 16 is a diagram illustrating a vertex coordinate change process.

FIG. 17 is a schematic diagram illustrating how three-dimensional mesh data about a subject is generated.

FIG. 18 is a flowchart illustrating an example of a mesh data generation process performed by a triangular patch generation unit.

FIG. 19 is a functional block diagram illustrating an example of a functional configuration of a rendering unit.

FIG. 20 is a diagram illustrating an example of an image to be encoded generated by a tiling unit in a second embodiment.

FIG. 21 is a functional block diagram illustrating an example of a functional configuration of a decoding unit and a rendering unit of the second embodiment.

FIG. 22 is a diagram illustrating visibility check.

FIG. 23 is a diagram illustrating the function of an information processing system according to a third embodiment.

FIG. 24 is a diagram illustrating the function of an information processing system according to a fourth embodiment.

### DESCRIPTION OF EMBODIMENTS

Embodiments of the present disclosure will be described below in detail with reference to the drawings. Note that in the following embodiments, the same portions are denoted by the same reference numerals and symbols, and a repetitive description thereof will be omitted.

Furthermore, the present disclosure will be described in the order of items shown below.

### 1. First Embodiment

1-1. Functional configuration of information processing system
1-2. Process performed by information processing system
1-3. Hardware configuration of information Processing System
1-4. Detailed configuration of encoding unit
1-5. Detailed configuration of decoding unit
1-6. Depth validity determination process
1-7. Mesh data generation process
1-8. Detailed configuration of rendering unit
1-9. Modifications of first embodiment
1-10. Effects of first embodiment

### 2. Second Embodiment

2-1. Configuration of tiling image
2-2. visibility check
2-3. Effects of second embodiment

### 3. Third Embodiment

3-1. Function of third embodiment
3-2. Effects of third embodiment

### 4. Fourth Embodiment

4-1. Function of fourth embodiment
4-2. Effects of fourth embodiment

### 5. Application Examples of Present Disclosure

5-1. Production of content
5-2. Experience in virtual space
5-3. Application to communication with remote location
5-4. Others

### 1. First Embodiment

### [1-1. Configuration of Information Processing System]

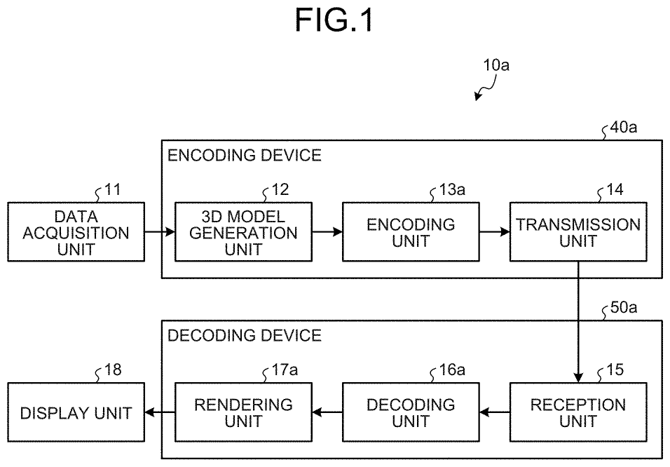

First, an overview of an information processing system 10a to which the present disclosure is applied will be described with reference to FIG. 1. FIG. 1 is a block diagram illustrating a schematic configuration of the information processing system according to a first embodiment.

As illustrated in FIG. 1, the information processing system 10a includes a data acquisition unit 11, a 3D model generation unit 12, an encoding unit 13a, a transmission unit 14, a reception unit 15, a decoding unit 16a, a rendering unit 17a, and a display unit 18.

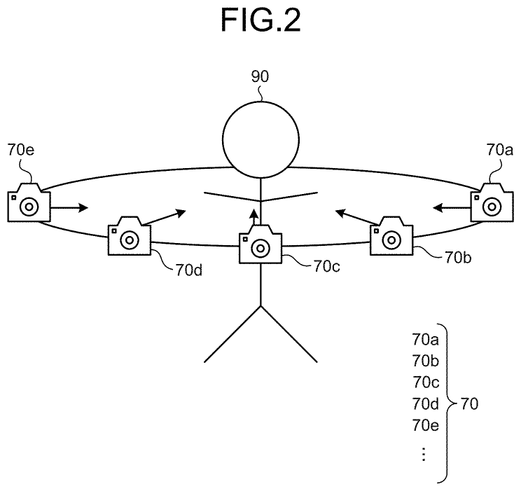

The data acquisition unit 11 acquires image data for generating a 3D model 90M of a subject 90 that is an object to be imaged. For example, as illustrated in FIG. 2, a plurality of viewpoint images captured by a plurality of imaging devices 70 (70a, 70b, . . . ) arranged so as to surround the subject 90 are acquired as the image data. In this configuration, the plurality of viewpoint images are preferably images captured by a plurality of cameras in synchronization with each other. Furthermore, the data acquisition unit 11 may acquire as the image data obtained, for example, by capturing images of the subject from a plurality of viewpoints by moving one camera. Note that the data acquisition unit 11 may perform calibration on the basis of the image data to acquire internal parameters and external parameters of each imaging device. Furthermore, the data acquisition unit 11 may acquire, for example, a plurality of pieces of depth information indicating distances from a plurality of viewpoints to the subject 90.

The 3D model generation unit 12 generates a model having three-dimensional information about the subject on the basis of the image data for generating the 3D model 90M of the subject 90. The 3D model generation unit 12 generates a 3D model of the subject by, for example, carving the three-dimensional shape of the subject according to images captured from a plurality of viewpoints (e.g., silhouette images captured from a plurality of viewpoints) by using so-called Visual Hull. In this configuration, the 3D model generation unit 12 can further deform the 3D model 90M generated using the Visual Hull with high accuracy by using the plurality of pieces of depth information indicating distances from the plurality of viewpoints to the subject. Furthermore, the 3D model generation unit 12 may generate the 3D model 90M of the subject 90 from one captured image of the subject 90.

The 3D model 90M that is generated in time series in frames by the 3D model generation unit 12 can also be referred to as a moving image of the 3D mode. Furthermore, the 3D model 90M is generated using images captured by the imaging devices, and therefore, the 3D model 90M can also be referred to as a live-action 3D model. In the 3D model, shape information indicating the surface shape of the subject 90 can be expressed in the form of, for example, three-dimensional mesh data expressed by connection between vertices which is called polygon mesh. The three-dimensional mesh data includes, for example, three-dimensional coordinates of the vertices of the mesh and index information indicating whether which vertices are combined to form a triangle mesh. Note that the expressions of the 3D model are not limited thereto, and the 3D model may be described by an expression method using so-called point cloud expressed by point position information. Color information data is also generated as a texture in association with 3D shape data of the above expressions. For the texture, view-independent texture that provides a color constant even if viewed from any direction or view-dependent texture that provides a color changing depending on the viewing direction is considered.

The encoding unit 13a converts the data about the 3D model 90M generated by the 3D model generation unit 12 into a format suitable for transmission and accumulation of the data. In the present embodiment, three-dimensional shape data input having a format such as the three-dimensional mesh data is converted into a depth information image, so-called depth map, projected from one or a plurality of viewpoints. The depth information and the color information that are a two-dimensional image are compressed and output to the transmission unit 14. The depth information and the color information may be transmitted side by side as one image or may be transmitted as two separate images. Both are in the form of two-dimensional image data, and can also be compressed using a two-dimensional compression technique such as advanced video coding (AVC).

The transmission unit 14 transmits transmission data formed by the encoding unit 13a to the reception unit 15. The transmission unit 14 transmits the transmission data to the reception unit 15, after a series of processing by the data acquisition unit 11, the 3D model generation unit 12, and the encoding unit 13a is performed offline. Furthermore, the transmission unit 14 may transmit the transmission data generated from the series of processing described above, to the reception unit in real time.

Note that the 3D model generation unit 12, the encoding unit 13a, and the transmission unit 14 constitute an encoding device 40a. The encoding device 40a is an example of an information processing device in the present disclosure.

The reception unit 15 receives the transmission data transmitted from the transmission unit 14.

The decoding unit 16a restores the two-dimensional image from a bit stream received by the reception unit 15, and restores the mesh and texture information for drawing by the rendering unit 17a, from the restored two-dimensional image.

Note that the reception unit 15, the decoding unit 16a, and the rendering unit 17a constitute a decoding device 50a. The decoding device 50a is an example of the information processing device in the present disclosure.

The rendering unit 17a performs texture mapping by projecting the mesh of the 3D model 90M with a viewpoint of drawing camera and mapping the texture representing color or a pattern. The present embodiment is characterized in that the drawing at this time can be viewed from any freely set viewpoint, regardless of a camera position upon image capturing. The texture mapping includes so-called view dependent method (VD method) in which a viewing viewpoint of the user is considered and so-called view independent (VI method) method in which the viewing viewpoint of the user is not considered. In the VD method, the texture to be mapped to the 3D model is changed according to the position of the viewing viewpoint, and therefore, there is an advantage that rendering with higher quality than that of the VI method can be implemented. On the other hand, in the VI method, the position of the viewing viewpoint is not considered, and therefore, there is an advantage that smaller amount of processing is required relative to that in the VD method. Note that the data about the viewing viewpoint is input from the display device to the rendering unit 17a, on the basis of detection of a viewing point (region of interest) of the user by the display device.

The display unit 18 displays a result of rendering by the rendering unit 17a, on the display unit of the display device. The display device may be a 2D monitor or 3D monitor, such as a head mounted display, spatial display, mobile phone, TV set, or PC.

Note that the information processing system 10a in FIG. 1 shows a series of processing steps from the data acquisition unit 11 that acquires the captured image being a material for generation of content to the display control unit that controls the display device viewed by the user. However, it does not mean that all functional blocks are necessary for implementation of the present embodiment, but means that the present embodiment can be implemented for each functional block or a combination of a plurality of the functional blocks. For example, in FIG. 1, the transmission unit 14 and the reception unit 15 are provided to show a series of processing steps from a side of creating the content to a side of viewing the content through distribution of content data. However, in a case where the creation of the content to the viewing of the content is performed by the same information processing device (e.g., a personal computer), it is not necessary to provide the transmission unit 14 and the reception unit 15.

In some cases, the information processing system 10a may be implemented by the same implementer for all functional blocks, or may be performed by different implementers for the respective functional blocks. For example, a company A generates 3D content through the data acquisition unit 11, the 3D model generation unit 12, and the encoding unit 13a. In addition, the 3D content is distributed through the transmission unit 14 (platform) of a company B and the display device of a company C performs reception, rendering, display control of the 3D content. In some cases, there may be such a case of cooperation of a plurality of implementers with each other.

Furthermore, each functional block described above can be implemented on cloud computing. For example, the rendering unit 17a may be implemented by the display device or may be implemented by a server. In this configuration, information is exchanged between the display device and the server.

In FIG. 1, the data acquisition unit 11, the 3D model generation unit 12, the encoding unit 13a, the transmission unit 14, the reception unit 15, the rendering unit 17a, and the display unit 18 are collectively described as the information processing system 10a. However, in the information processing system 10a of the present description, two or more functional blocks that are related to each other is referred to as information processing system, and, for example, the data acquisition unit 11, the 3D model generation unit 12, the encoding unit 13a, the transmission unit 14, the reception unit 15, the decoding unit 16a, and the rendering unit 17a, excluding the display unit 18, can be collectively referred to as the information processing system 10a.

### [1-2. Process Performed by Information Processing System]

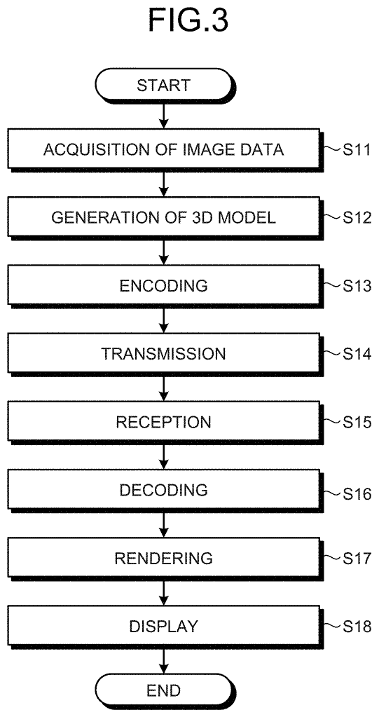

Next, a process performed by the information processing system 10a will be described with reference to FIG. 3. FIG. 3 is a flowchart illustrating an example of the process performed by the information processing system.

When the process is started, in Step S11, the data acquisition unit 11 acquires the image data for generating the 31) model of the subject.

Next, in Step S12, the 3D model generation unit 12 generates the 3D model having three-dimensional information about the subject, on the basis of the image data for generating the 3D model of the subject.

In Step S13, the encoding unit 13a encodes the shape and texture data of the 3D model generated by the 3D model generation unit 12 into a format suitable for transmission/accumulation.

Then, in Step S14, the transmission unit 14 transmits the encoded data, and in Step S15, the reception unit 15 receives the transmitted data.

In Step S16, the decoding unit 16a performs decode processing to convert the 3D model into shape and texture data necessary for display. Then, in Step S17, the rendering unit 17a performs rendering by using the shape and texture data. A rendered result is displayed on the display unit in Step S18. Then, when the processing of Step S18 is finished, the process of the information processing system 10a ends.

### [1-3. Hardware Configuration of Information Processing System]

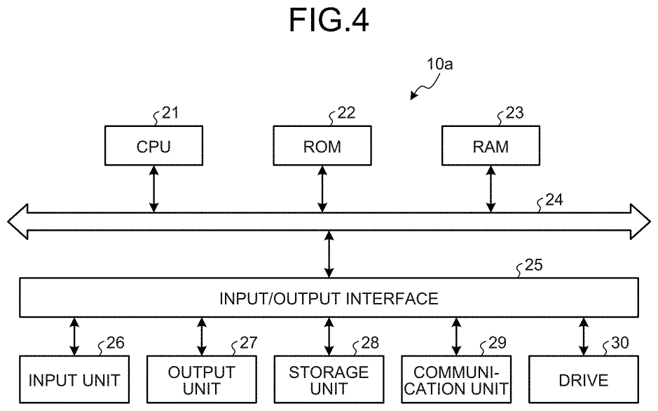

Next, a hardware configuration of the information processing system 10a will be described with reference to FIG. 4. FIG. 4 is a hardware block diagram illustrating an example of the hardware configuration of the information processing system.

In a computer illustrated in FIG. 4, a CPU 21, a ROM 22, and a RAM 23 are connected to each other via a bus 24. An input/output interface 25 is also connected to the bus 24. An input unit 26, an output unit 27, a storage unit 28, a communication unit 29, and a drive 30 are connected to the input/output interface 25.

The input unit 26 includes, for example, a keyboard, a mouse, a microphone, a touch panel, an input terminal, and the like. The output unit 27 includes, for example, a display, a speaker, an output terminal, and the like. The storage unit 28 includes, for example, a hard disk, a RAM disk, a non-volatile memory, and the like. The communication unit 29 includes, for example, a network interface, and the like. The drive 30 drives a removable medium such as a magnetic disk, optical disk, magneto-optical disk, or semiconductor memory.

In the computer configured as described above, the CPU 21 loads a program stored in the storage unit 28 into the RAM 23 via the input/output interface 25 and the bus 24, and executes the series of processing steps described above. The RAM 23 also appropriately stores data necessary to execute various processing by the CPU 21.

For example, the program executed by the computer can be applied by being recorded in the removable medium, as a package medium or the like. In this configuration, when the removable medium is mounted to the drive, the program can be installed in the storage unit 28 via the input/output interface.

Furthermore, the program can also be provided via a wired or wireless transmission medium such as a local area network, the Internet, and digital satellite broadcast. In this configuration, the program is allowed to be received by the communication unit 29 and installed in the storage unit 28.

### [1-4. Detailed Configuration of Encoding Unit]

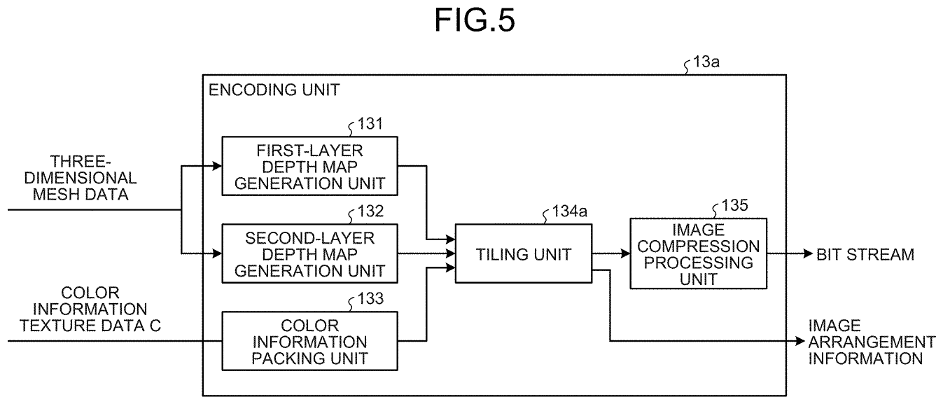

Next, a detailed configuration of the encoding unit 13a will be described with reference to FIG. 5. FIG. 5 is a functional block diagram illustrating an example of a functional configuration of an encoding unit.

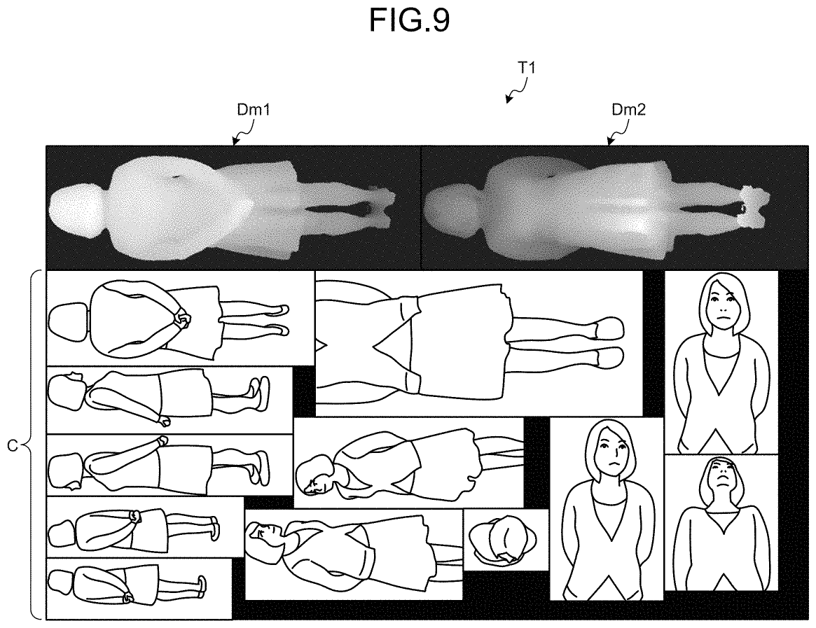

The encoding unit 13a receives the three-dimensional mesh data and color information texture data C (see FIG. 9) of the subject 90, from the 3D model generation unit 12. Then, the encoding unit 13a converts the three-dimensional mesh data and the color information texture data C into bit stream data suitable for transmission/accumulation, and outputs the bit stream data. As illustrated in FIG. 5, the encoding unit 13a includes a first-layer depth map generation unit 131, a second-layer depth map generation unit 132, a color information packing unit 133, a tiling unit 134a, and an image compression processing unit 135.

On the basis of the 3D shape acquired by the 3D model generation unit 12, the first-layer depth map generation unit 131 acquires a first distance d1 between a first point P1 at which a straight line extending from a projecting point Q as a start point to the subject 90 comes into contact with the subject 90, and the projecting point Q. Then, the first-layer depth map generation unit 131 generates an image visualizing the distance to a surface of the subject 90 as viewed from the projecting point Q, that is, a first-layer depth map Dm1. Note that the first-layer depth map generation unit 131 is an example of a distance acquisition unit in the present disclosure.

On the basis of the 3D shape acquired by the 3D model generation unit 12, the second-layer depth map generation unit 132 acquires a second distance d2 between the projecting point Q and a second point P2 from which a straight line starting from the projecting point Q, as the start point, and extending through the inside of the subject 90 from the first point P1 passes to the outside of the subject 90. Then, the second-layer depth map generation unit 132 generates an image visualizing the distance to a back surface of the subject 90 as viewed from the projecting point Q, that is, a second-layer depth map Dm2. Note that the second-layer depth map generation unit 132 is an example of the distance acquisition unit in the present disclosure. Note that the straight line extending from the projecting point Q as the start point to the subject 90 may pass through the subject 90 a plurality of times, in some cases. In such a configuration, a plurality of pairs of the first and second points P1 and P2 are generated. In other words, each time the straight line passes through the subject 90, the pair of the first and second points P1 and P2 is generated.

As described above, the three-dimensional shape of the subject 90 is restored in the 3D model generation unit 12. Therefore, when perspective transformation is performed on the three-dimensional shape of the subject 90 from any viewpoint, the distance to the front surface of the subject 90 can be expressed as an image. This image provides the first-layer depth map Dm1 and the second-layer depth map Dm2 described above.

Note that the perspective transformation is calculated by, for example, Formula (1).

$$s [ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}X \\ Y \\ Z \\ 1\end{matrix} ] \qquad ( 1 )$$

Formula (1) indicates that two-dimensional coordinates (u, v) and a depth s of a projection plane are obtained by multiplying a matrix of camera external parameters including rotational components r11 to r33 and translation components t1 to t3 and a matrix of camera internal parameters represented by fx, fy and cx, cy, by a point (X, Y, Z) cn the subject 90.

The first-layer depth map Dm1 has two-dimensional array data in which a distance to the very front point of all projected faces of the three-dimensional mesh of the subject 90 viewable from the projecting point Q is stored, that is, the distance to the nearest point from the projecting point Q.

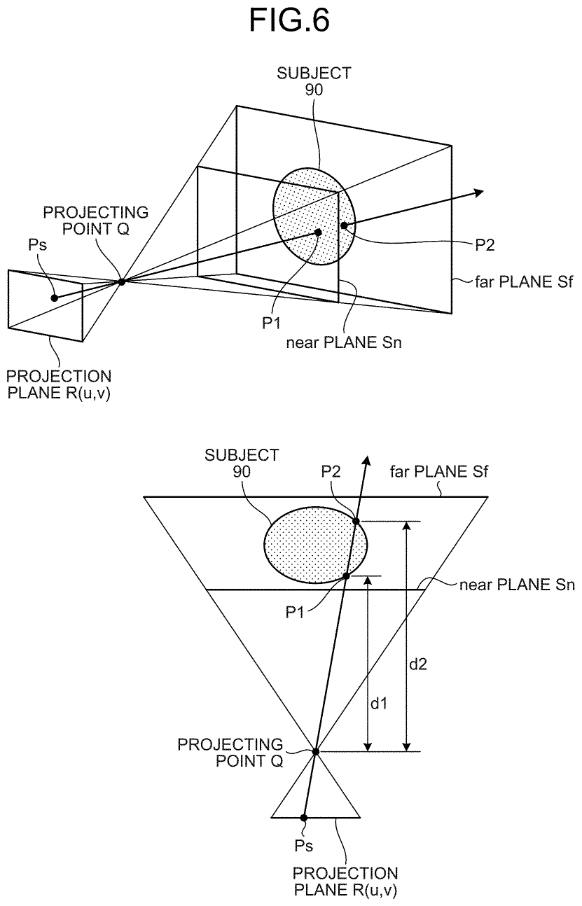

In the present embodiment, in addition to the first-layer depth map Dm1, the second-layer depth map Dm2 that records the distance to a surface of the subject 90 on the back side is also used. FIG. 6 is a diagram illustrating a method of generating the depth maps.

The first-layer depth map generation unit 131 quantizes the depth s calculated as the first distance d1 in the range of the minimum value and the maximum value and stores the depth s at a point Ps on a projection plane R (u, v) illustrated in FIG. 6. The minimum value is, for example, a distance near from the projecting point Q to a near plane Sn in FIG. 6, and the maximum value is, for example, a distance far from the projecting point Q to a far plane Sf in FIG. 6.

In the present embodiment, for example, the depth is stored in an 8-bit brightness value so as to be compressed by advanced video coding (AVC). In other words, the first distance d1 is converted into a quantized depth value D1 by a calculation formula shown in Formula (2).

Note that D1=0 is stored in an area where the subject 90 is not positioned. Note that, hereinafter, the quantized depth value D1 is simply referred to as depth value D1.

$${D}_{1} = round ( 255 \cdot \frac{d 1 - far}{near - f a r} ) \qquad ( 2 )$$

The second-layer depth map generation unit 132 uses a perspective projection parameter the same as that used for the first layer, but stores the depth s calculated as the second distance d2 extending through the inside of the subject 90 to the point on the back side of the subject 90, at the point Ps on the projection plane R (u, v) illustrated in FIG. 6. In an area of the depth map where the subject 90 is projected, the second distance d2 has a value larger than that of the first distance d1. A quantized depth value D2 of the second layer is calculated by Formula (3) in which the distance near and the distance far in Formula (2) are interchanged so that the quantized depth value D2 has a value, the magnitude of which is reversed from that of the depth value D1 of the first layer. Note that D2=0 that represents an invalid value is stored in an area where the subject 90 is not positioned. This invalid value (D2=0) is a value the same as a value obtained when the second distance d2 is equal to the distance near. Note that round (x) in Formula (2) is a function of rounding x to an integer. Hereinafter, the quantized depth value D2 is simply referred to as depth value D2.

$${D}_{2} = round ( 255 \cdot \frac{d 2 - far}{near - f a r} ) \qquad ( 3 )$$

Note that although FIG. 6 illustrates an example of the generation of the depth maps by perspective projection with the projecting point Q as the projection center, the depth maps may be generated using a projection method other than the perspective projection, for example, parallel projection.

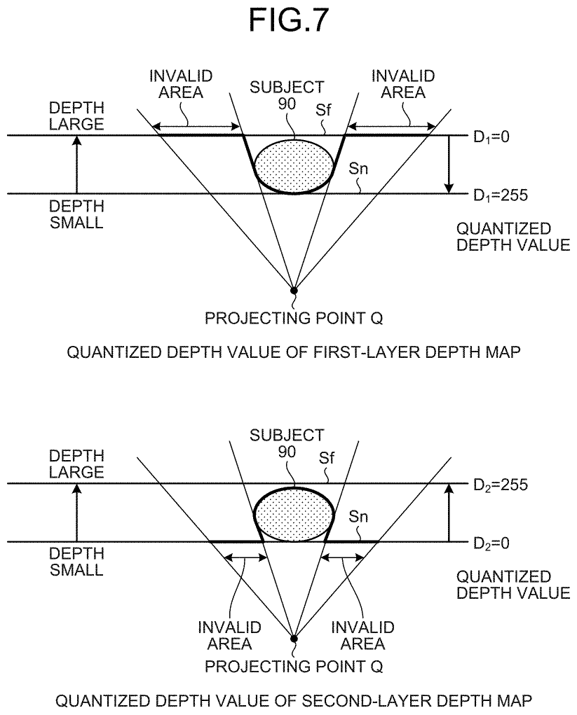

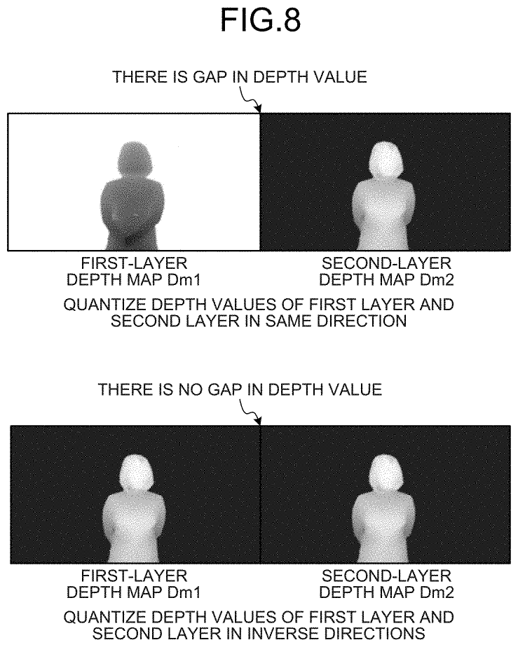

Next, specific examples of the first-layer depth map Dm1 and the second-layer depth map Dm2 will be described with reference to FIGS. 7 and 8. FIG. 7 is a diagram illustrating the quantized depth values of the first-layer depth map and the second-layer depth map. FIG. 8 is a diagram illustrating an example of the first-layer depth map and the second-layer depth map.

As illustrated in FIG. 7, the encoding unit 13a stores the depth value D1 in an area where the subject 90 is not positioned (invalid area) that is to be stored in the first-layer depth map Dm1, in the near plane Sn, as the distance far. In addition, the depth value D2 in an area where the subject 90 is not positioned (invalid area) that is to be stored in the second-layer depth map Dm2 is stored in the far plane Sf, as the distance near smaller than the distance far. Note that the distance far is an example of a first distance value in the present disclosure. The distance near is an example of a second distance value in the present disclosure. Therefore, it is possible to determine that an area where d1<d2 is an area indicating the subject 90.

Furthermore, the encoding unit 13a reverses a quantization direction between the first layer and the second layer as expressed in Formulas (2) and (3). Therefore, as illustrated in FIG. 7, the depth values D1 and D2 corresponding to the invalid area after the quantization are set to equal values, that is, both the depth value D1 and the depth value D2 are set to 0.

If the quantization direction is the same between the first layer and the second layer, the first-layer depth map Dm1 and the second-layer depth map Dm2 that are arranged in one image has a gap in depth value on the boundary, as illustrated in the upper diagram of FIG. 8. On the other hand, reversing the quantization direction between the first layer and the second layer does not generate the gap in depth value on the boundary between the first-layer depth map Dm1 and the second-layer depth map Dm2 that are arranged in the one image, as illustrated in the lower diagram of FIG. 8. Therefore, in encoding the first-layer depth map Dm1 and the second-layer depth map Dm2 that are arranged in one image, compression efficiency of the image can be enhanced.

Note that the quantization method described here is an example, and a quantization method other than the linear quantization given in Formulas (2) and (3) may be applied. For example, reciprocal quantization given in Formula (4) may be applied. According to Formula (4), quantization is performed using a coarser step size as the distance increases.

$${D}_{1}^{′} = round ( 255 \cdot ( \frac{1}{d 1} - \frac{1}{far} ) / ( \frac{1}{near} - \frac{1}{far} ) ) \qquad ( 4 )$$

Returning to FIG. 5, the color information packing unit 133 performs processing of arranging (packing) the plurality of pieces of color information texture data C input from the 3D model generation unit 12 in one image. This processing makes it possible to reduce the number of images to be transmitted to the decoding device 50a. Note that the color information texture data C is an example of the texture information in the present disclosure.

The tiling unit 134a performs processing of collecting the first-layer depth map Dm1, the second-layer depth map Dm2, and the color information texture data C packed by the color information packing unit 133 into one image. The values (depth values D1 and D2) stored in the first-layer depth map Dm1 and the second-layer depth map Dm2 are converted into a signal format of Y/Cb/Cr (luminance signal and color difference signal) so to be arranged in the same image in which the color information is arranged. In other words, the depth values D1 and D2 are stored in the brightness value. Furthermore, a constant value, for example, a constant value such as 128 indicating gray is stored in the color difference, when an image is 8 bits per pixel. In addition, the tiling unit 134a outputs image arrangement information indicating whether the depth map and the color information texture data C are stored at which position of one collected image. The image arrangement information includes, for example, an offset value indicating whether how much the original image has moved and arranged in one image, values of distances near and far that are used for quantization of the depth maps, the position of the projecting point Q, and the like.

FIG. 9 is a diagram illustrating an example of an image generated by the tiling unit. The tiling unit 134a collects the first-layer depth map Dm1, the second-layer depth map Dm2, and the color information texture data C into one tiling image T1. As illustrated in FIG. 9, the color information texture data C is actual images obtained by capturing the subject 90 by the plurality of the imaging devices 70 (see FIG. 2).

The image compression processing unit 135 uses a general video codec to compress the images collected into one image in the tiling unit 134a. Specifically, a widely used codec such as AVC or HEVC is used.

Note that, in the above Formulas (2) and (3), the depth values D1 and D2 are quantized with values of 0 to 255 on the assumption that the depth values D1 and D2 are 8 bits. However, a 10-bit value can be handled in the HEVC or the like, and the depth values D1 and D2 may be quantized with 10 bits (0 to 1023).

The bit stream generated by the image compression processing unit 135 and the image arrangement information generated by the tiling unit 134a are transmitted to the decoding device 50a via the transmission unit 14. In other words, the transmission unit 14 transmits the first distance d1 and the second distance d2 in association with each other, to the decoding device 50a that reconstructs the three-dimensional shape of the subject 90.

### [1-5. Detailed Configuration of Decoding Unit]

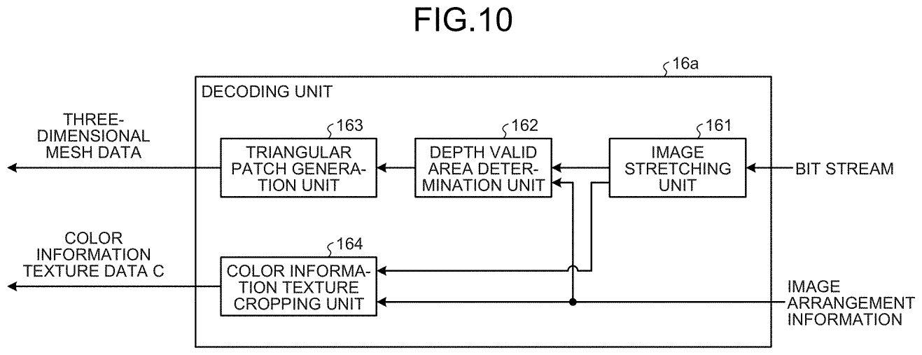

Next, a detailed configuration of the decoding unit 16a will be described with reference to FIG. 10. FIG. 10 is a functional block diagram illustrating an example of a functional configuration of the decoding unit.

As illustrated in FIG. 10, the decoding unit 16a includes an image decompression processing unit 161, a depth valid area determination unit 162, a triangular patch generation unit 163, and a color information texture cropping unit 164. The decoding device 50a (see FIG. 1) including the decoding unit 16a acquires the first distance dl between the projecting point Q and the first point P1 at which the straight line extending from the projecting point Q to the subject 90 comes into contact with the subject 90, and the second distance d2 between the projecting point Q and the second point P2 from which the straight line extending through the inside of the subject 90 from the first point P1 passes to the outside of the subject 90, on the basis of the information transmitted from the encoding device 40a, that is, a 3D shape of the surface of the subject 90, and associates the position of the projecting point Q, the first distance d1, and the second distance d2 to generate the 3D model 90M of the subject 90.

The image decompression processing unit 161 decompresses the bit stream compressed by the image compression processing unit 135 into an image. Note that encoding and decoding are paired, and therefore, for example, an AVC encoded bit stream is decoded by AVC decoding processing.

The depth valid area determination unit 162 identifies an area of the subject 90, on the basis of a magnitude relationship between the first distance d1 stored in the first-layer depth map Dm1 acquired by the first-layer depth map generation unit 131 and the second distance d2 stored in the second-layer depth map Dm2 acquired by the second-layer depth map generation unit 132. More specifically, the depth valid area determination unit 162 determines an area on which the subject 90 is projected as a valid area, and determines an area on which the subject 90 is not projected as the invalid area. In the area determined as the valid area, the stored depth values D1 and D2 are used to reconstruct the shape of the subject 90. Meanwhile, the data of the area determined to be the invalid area is discarded without being used for rendering. Note that the depth valid area determination unit 162 is an example of an area determination unit in the present disclosure. Furthermore, details of a process performed by the depth valid area determination unit 162 will be described later.

The triangular patch generation unit 163 generates shape data, so-called mesh data, that is available for rendering processing, on the boundary between the inside of the subject 90 and the outside of the subject 90. In addition, the triangular patch generation unit 163 forms a closed space by connecting the front surface side end of the subject 90 that is obtained on the basis of the first distance d1 stored in the first-layer depth map Dm1 relating to the projecting point Q, and the back surface side end of the subject 90 that is obtained on the basis of the second distance d2 stored in the second-layer depth map Dm2 relating to the projecting point Q. Note that the triangular patch generation unit 163 is an example of a closed space generation unit in the present disclosure. Details of the processing performed by the triangular patch generation unit 163 will be described later.

On the basis of information about the image decoded by the image decompression processing unit 161 and the image arrangement information generated by the tiling unit 134a, the color information texture cropping unit 164 generates the color information texture data C to be mapped to the three-dimensional mesh data in the subsequent rendering unit 17a.

### [1-6. Depth Validity Determination Process]

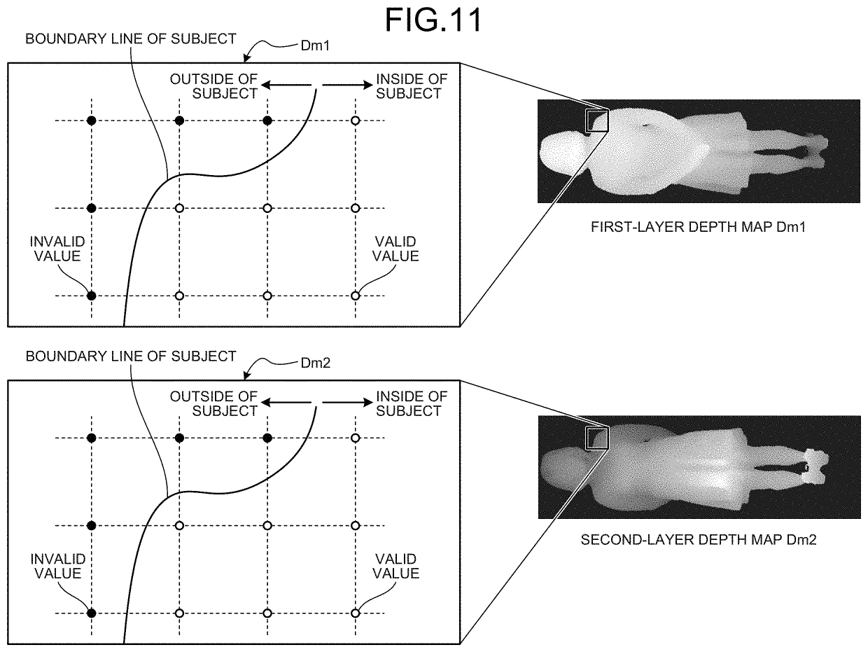

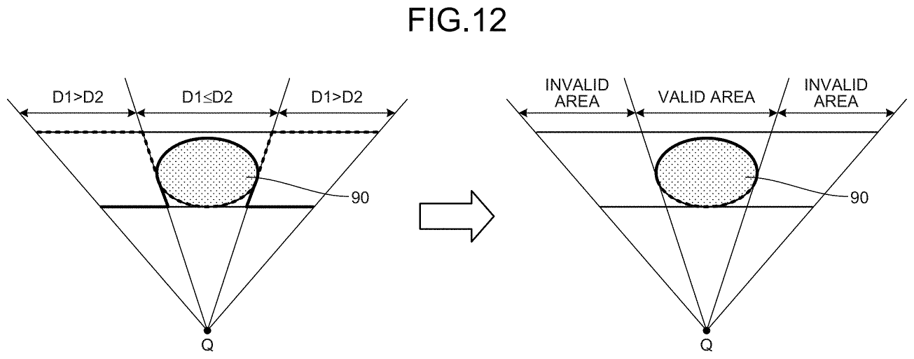

Next, a depth valid area determination process performed by the depth valid area determination unit 162 will be described with reference to FIGS. 11 and 12. FIG. 11 is a diagram illustrating a method of reading a depth value from each of the depth maps by a depth valid area determination unit. FIG. 12 is a diagram illustrating a method of determining validity/invalidity of the depth value by the depth valid area determination unit.

The first-layer depth map Dm1 and the second-layer depth map Dm2 illustrated on the left side of FIG. 11 are obtained by enlarging portions (portions of the shoulders of the subject) of the first-layer depth map Dm1 and the second-layer depth map Dm2 illustrated on the right side. In FIG. 11, a white circle represents a point inside the subject, that is, a point at which the depth value D1 or the depth value D2 that is valid is stored. Furthermore, a black circle represents a point outside the subject, that is, a point at which the depth value D1 or the depth value D2 that is invalid is stored. In other words, the first-layer depth map Dm1 and the second-layer depth map Dm2 illustrated on the left side of FIG. 11 should actually be represented by curved surfaces having points storing the depth values, but are drawn on a plane for ease of understanding the description.

Reading points of the first-layer depth map Dm1 and the second-layer depth map Dm2 are arranged in a square grid as illustrated in FIG. 11. The grid interval of the grid may be set freely. Furthermore, the position of each of the reading points of the depth maps does not necessarily need to match each pixel position, of each depth map. When the reading point and the pixel position are not matched, a depth value interpolated by an interpolation filter is used.

The triangular patch generation unit 163 which is described later performs drawing processing in units of triangles connecting three depth reading points, and therefore, the smaller the grid interval of the reading points, the larger the amount of the drawing processing. On the other hand, when the grid interval of the reading points is set large, a load on the drawing processing is reduced, and this makes it possible to adjust the processing load on the decoding device 50a.

Of the depth values D1 and D2 read from the depth reading points, the depth value D1 of the front surface of the subject 90 is stored in the first layer in the valid area, that is, the area where the subject 90 is positioned. The depth value D2 of the back surface of the subject 90 is stored in the second layer. Meanwhile, in the invalid area, that is, the area where the subject 90 is not positioned, a far value is stored in the first layer, and a near value is stored in the second layer. Therefore, as illustrated in the left diagram of FIG. 12, D1≤D2 is satisfied in the valid area. Note that, in a case where the subject 90 is very thin in a depth direction, it is considered that the front surface and the back surface have an equal depth value in quantization, and thus D1≤D2 is also included. Meanwhile, D1>D2 is satisfied in the invalid area.

The depth values D1 and D2 are compressed in transmission, and thus, the depth values D1 and D2 are deteriorated due to a compression error. In particular, there is a possibility that the boundary of the subject 90 may have a large gap in depth value. However, in the present embodiment, the valid area of the subject 90 is determined by relative comparison between the first layer and the second layer, and the valid areas of the first layer and the second layer completely match each other as illustrated in the right diagram of FIG. 12.

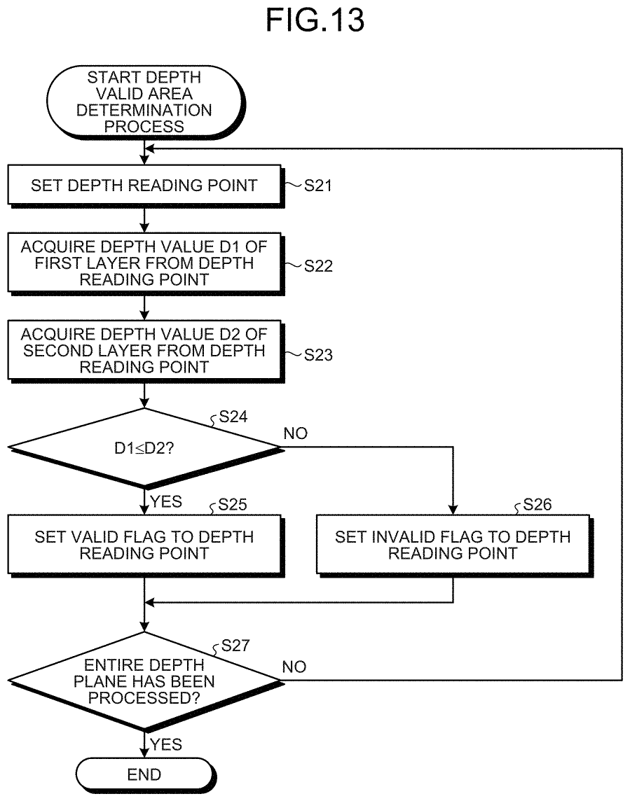

Next, the depth valid area determination process performed by the depth valid area determination unit 162 will be described with reference to FIG. 13. FIG. 13 is a flowchart illustrating an example of the process performed by the depth valid area determination unit.

The depth valid area determination unit 162 sets a depth reading point (Step S21).

The depth valid area determination unit 162 acquires the depth value D1 of the first layer from the first-layer depth map Dm1 (Step S22).

Subsequently, the depth valid area determination unit 162 acquires the depth value D2 of the second layer from the second-layer depth map Dm2 (Step S23).

The depth valid area determination unit 162 determines whether the depth value D1 of the first layer is equal to or less than the depth value D2 of the second layer (Step S24). When it is determined that the depth value D1 of the first layer is equal to or less than the depth value D2 of the second layer (Step S24: Yes), the process proceeds to Step S25. On the other hand, when it is not determined that the depth value D1 of the first layer is equal to or less than the depth value D2 of the second layer (Step S24: No), the process proceeds to Step S26.

If Yes in Step S24, the depth valid area determination unit 162 determines that the depth reading point is included in the area of the subject 90 and sets a valid flag to the depth reading point (Step S25). Then, the process proceeds to Step S27.

On the other hand, if No in Step S24, the depth valid area determination unit 162 determines that the depth reading point is not included in the area of the subject 90 and sets an invalid flag to the depth reading point (Step S26). Then, the process proceeds to Step S27.

The depth valid area determination unit 162 determines whether depth planes have been entirely processed (Step S27). When it is determined that the depth planes have been entirely processed (Step S27: Yes), the depth valid area determination unit 162 finishes the process of FIG. 13. On the other hand, when it is not determined that the depth planes have been entirely processed (Step S27: No), the process returns to Step S21, and a series of process steps described above is repeated for a different depth reading point.

Note that the valid flag may be set to all the depth reading points at first so that when it is determined as No in Step S24, the valid flag at a corresponding depth reading point may be put down.

### [1-7. Mesh Data Generation Process]

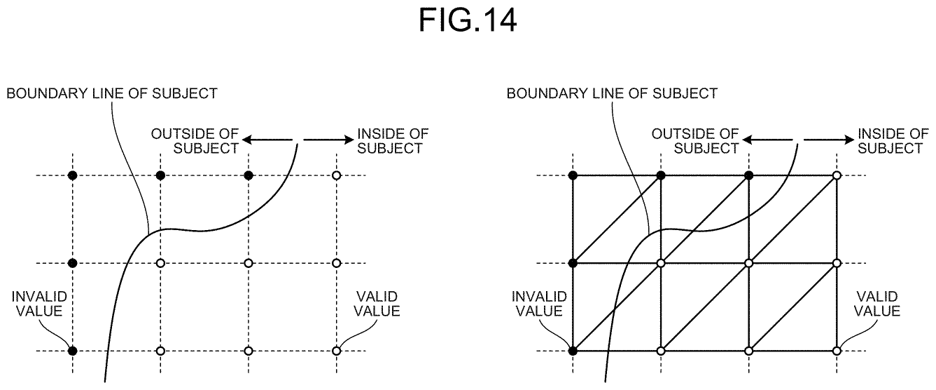

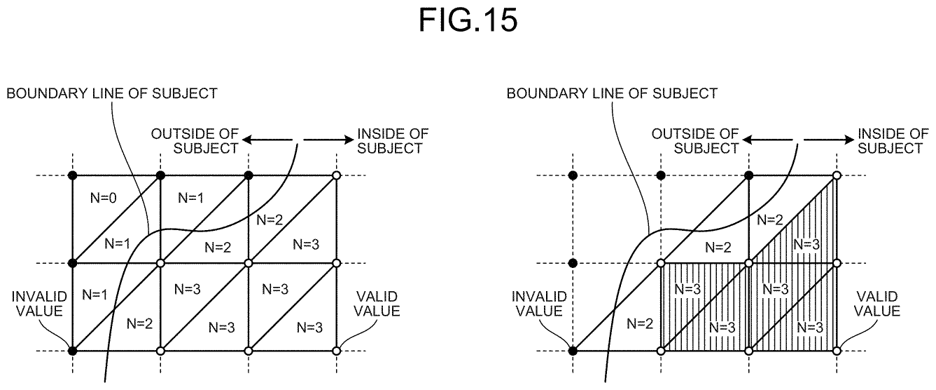

Next, a mesh data generation process performed by the triangular patch generation unit 163 will be described with reference to FIGS. 14 and 15. FIG. 14 is a diagram illustrating triangular patches set on each depth map. FIG. 15 is a diagram illustrating the number of valid points of the respective triangular patches.

The depth values D1 and D2 read from the reading points on the square grid and the valid flags thereof are input from the depth valid area determination unit 162 to the triangular patch generation unit 163. The left diagram of FIG. 14 illustrates an example of a state in which the depth reading points and the valid flags thereof are detected.

As illustrated in the right diagram of FIG. 14, the triangular patch generation unit 163 generates a graph structure in which two right triangles are assigned to one cell of the square grid. The graph structure has a triangular shape in which three adjacent depth reading points are connected as vertices. Note that the right diagram of FIG. 14 illustrates one layer, and actually, similar graph structures are generated for the first-layer depth map Dm1 and the second-layer depth map Dm2.

The triangular patch generation unit 163 performs the following processing in units of the triangular patches generated in this way. Then, the triangular patch generation unit 163 passes the group of triangles (mesh data) that is subjected to coordinate transformation process on the basis of the triangular patches, to the subsequent rendering unit 17a.

As illustrated in FIG. 15, the triangular patch generation unit 163 counts the number N of valid points, for each triangular patch. Specifically, the number N of valid points is a value indicating whether how many of the three vertices of a triangular patch of interest belong to the inside of the subject 90. The number N of valid points is an evaluation scale indicating whether the triangular patch of interest belongs to the inside of the subject 90.

In other words, the number N of valid points takes any value of 0, 1, 2, and 3. N=0 indicates that the triangular patch is completely positioned outside the subject 90. On the other hand, N=3 indicates that the triangular patch is completely positioned inside the subject 90. N=1 and N=2 indicate that the triangular patches extend inside and outside the subject 90.

When N=0 and N=1, the triangular patch generation unit 163 deletes the triangular patches as illustrated in the right diagram of FIG. 15. Then, the graph structure connecting the three vertices of the corresponding triangle is deleted.

On the other hand, when N=2 and N=3, the triangular patch generation unit 163 does not delete the triangular patches but leaves the triangular patches. Then, when N=3, inverse transformation (inverse perspective transformation) of Formula (1) is performed to obtain (X, Y, Z) from the coordinate position on the projection plane R (u, v) and the depth s stored at the coordinate position, for each of the three vertices of the triangular patch. When N=2, the above-described inverse perspective transformation is performed on two valid vertices of the triangular patch. Then, a vertex coordinate change process which is described later is performed on one invalid vertex. Note that other than N=2, the first layer and the second layer can be processed independently.

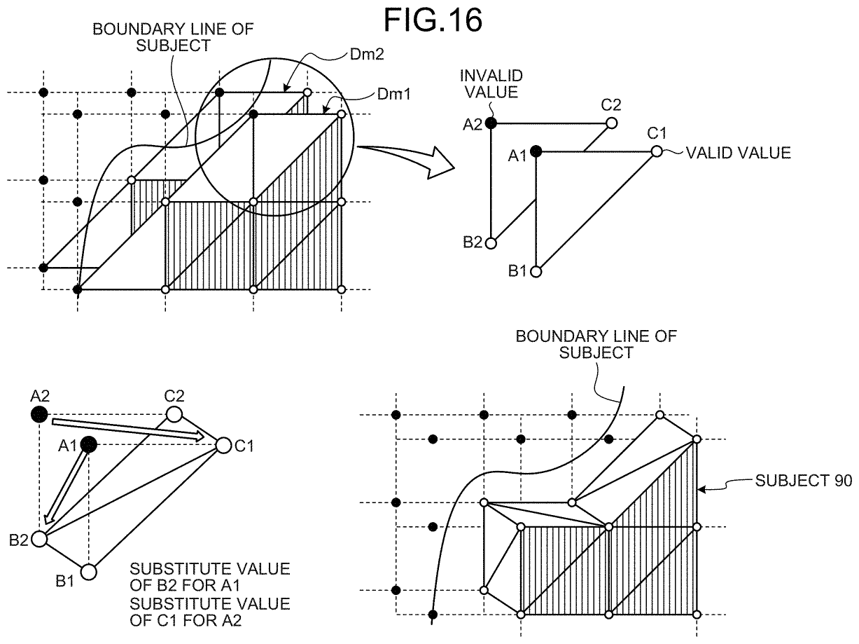

Next, the vertex coordinate change process performed by the triangular patch generation unit 163 when N=2 will be described with reference to FIG. 16. FIG. 16 is a diagram illustrating the vertex coordinate change process.

The upper left diagram of FIG. 16 illustrates a state in which the first-layer depth map Dm1 and the second-layer depth map Dm2 are arranged close to each other. The upper right diagram of FIG. 16 illustrates a state in which only one set of triangular patches satisfying N=2 is extracted. As illustrated in the upper right diagram of FIG. 16, when a triangular patch satisfying N=2 is generated in one depth map, a triangular patch satisfying N=2 is generated also at the same position in the opposite depth map.

As illustrated in the upper left diagram of FIG. 16, the vertices of the triangular patch of the first-layer depth map Dm1 are denoted by A1, B1, and C1. Then, the vertices of the triangular patch of the second-layer depth map Dm2 are denoted by A2, B2, and C2.

The triangular patch generation unit 163 performs the vertex change process on the vertices A1 and A2 that are invalid belonging to the outside of the subject 90.

In other words, as illustrated in the lower left diagram of FIG. 16, the triangular patch generation unit 163 substitutes the value (depth value D2) of the vertex B2 of the opposite depth map that is valid, for the invalid vertex A1. In other words, the vertex A1 is considered to be positioned at the vertex B2. In addition, the triangular patch generation unit 163 substitutes the value (depth value D1) of the vertex C1 of the opposite depth map that is valid, for the invalid vertex A2. In other words, the vertex A2 is considered to be positioned at the vertex C1. In this manner, the alternate substitution the values (depth values) of the valid vertices of the opposite depth maps for the invalid vertices connects a square B1-C1-C2-B2 are connected with two triangular patches. Therefore, an edge B1-C1 and an edge B2-C2 which are separated from each other are connected to each other with faces without a gap. In other words, the boundary between the front surface and the back surface of the subject 90 as viewed from the projecting point is connected seamlessly, and a closed solid (closed space) is formed. Note that a similar effect can also be obtained by substituting the depth value D2 of the vertex C2 for the vertex A1 and the depth value D1 of the vertex B1 for the vertex A2.

The above-described process is performed on all the triangular patches satisfying N=2 on the depth plane, the boundary between the front surface and the back surface of the subject 9C are seamlessly connected as illustrated in the lower right diagram of FIG. 16.

Note that, in FIG. 16, for ease of understanding the description, the depth value D1 of the first layer and the depth value D2 of the second layer that are substantially equal are described. However, in practice, the three-dimensional coordinates of each vertex are calculated from the depth value D1 of the first layer and the depth value D2 of the second layer by the inverse transformation of Formula (1), the vertices are arranged in a three-dimensional space, whereby the closed solid shape representing the subject 90 held between the depth planes of the two layers is reproduced.

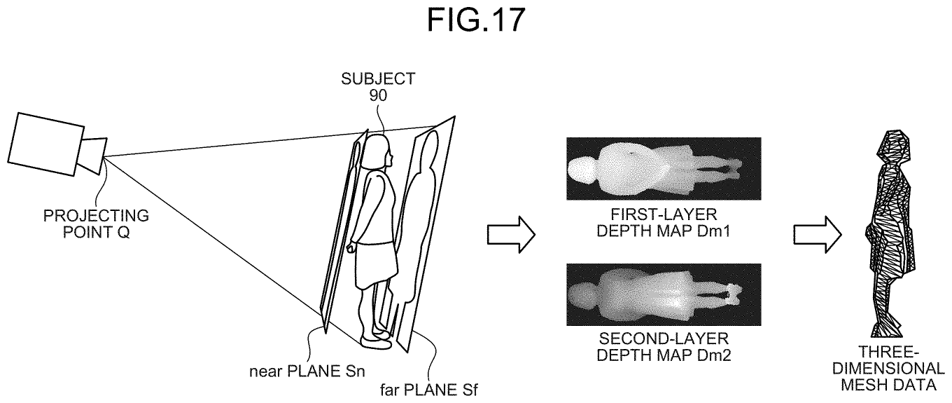

FIG. 17 is a schematic diagram illustrating how the three-dimensional mesh data about the subject is generated. As illustrated in FIG. 17, the three-dimensional mesh data is obtained in which an area of the subject 90 facing the projecting point Q and an area of the subject 90 on the back surface side to the projecting point Q are seamlessly connected.

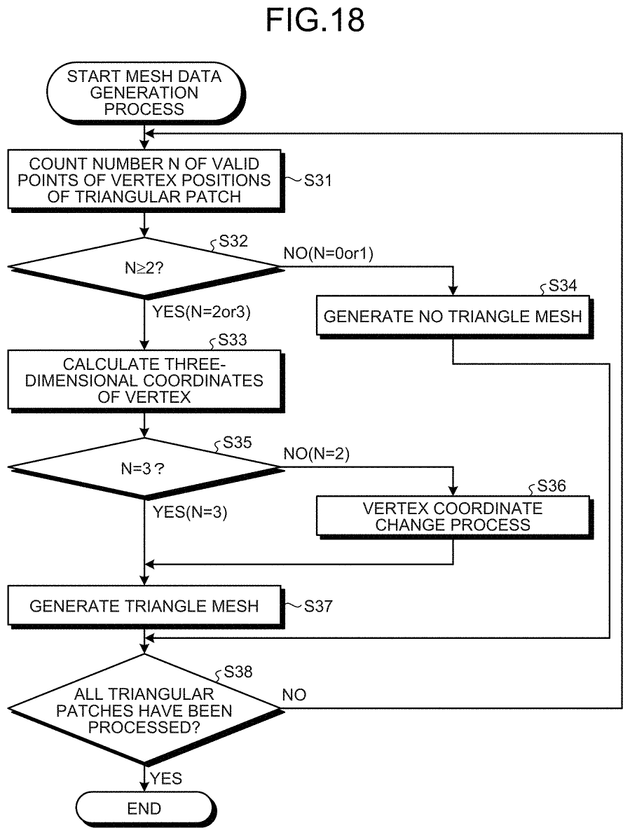

Next, the mesh data generation process performed by the triangular patch generation unit 163 will be described with reference to FIG. 18. FIG. 18 is a flowchart illustrating an example of the mesh data generation process performed by the triangular patch generation unit.

The triangular patch generation unit 163 counts the number N of valid points for each of the triangular patches generated as illustrated in the right diagram of FIG. 14 (Step S31).

The triangular patch generation unit 163 determines whether the number N of valid points counted in Step S31 is 2 or more (Step S32). When it is determined that the number N of valid points is 2 or more, that is, the number N of valid points is 2 or 3 (Step S32: Yes), the process proceeds to Step S33. On the other hand, when it is not determined that the valid point N is 2 or more (Step S32: No), that is, when it is determined that the number N of valid points is 0 or 1, the process proceeds to Step S34.

If Yes in Step S32, the triangular patch generation unit 163 calculates the three-dimensional coordinates of the vertices determined to be valid (Step S33). Then, the process proceeds to Step S35.

On the other hand, if No in Step S32, the triangular patch generation unit 163 generates no triangle mesh for the triangular patch of interest (Step S34). Then, the triangular patch of interest is erased so that the rendering is not performed thereon. Then, the process proceeds to Step S38.

Subsequent to Step S33, the triangular patch generation unit 163 determines whether the number N of valid points is 3 for the triangular patch of interest (Step S35). When it is determined that the number N of valid points is 3 (Step S35: Yes), the process proceeds to Step S37. On the other hand, when it is not determined that the number N of valid points is 3 (Step S35: No), that is, when it is determined that the number N of valid points is 2, the process proceeds to Step S36.

If No in Step S35, the triangular patch generation unit 163 performs the above-described vertex coordinate change process (see FIG. 16) (Step S36).

Subsequent to Step S36 or if Yes in Step S35, the triangular patch generation unit 163 generates the triangle mesh for the triangular patch of interest (Step S37).

The triangular patch generation unit 163 determines whether all the triangular patches are processed (Step S38). When it is determined that all the triangular patches are processed (Step S38: Yes), the triangular patch generation unit 163 finishes the process of FIG. 18. On the other hand, when it is not determined that all the triangular patches are processed (Step S38: No), the process returns o Step S31, and the series of process steps described above is repeated for a different triangular patch.

### [1-8. Detailed Configuration of Rendering Unit]

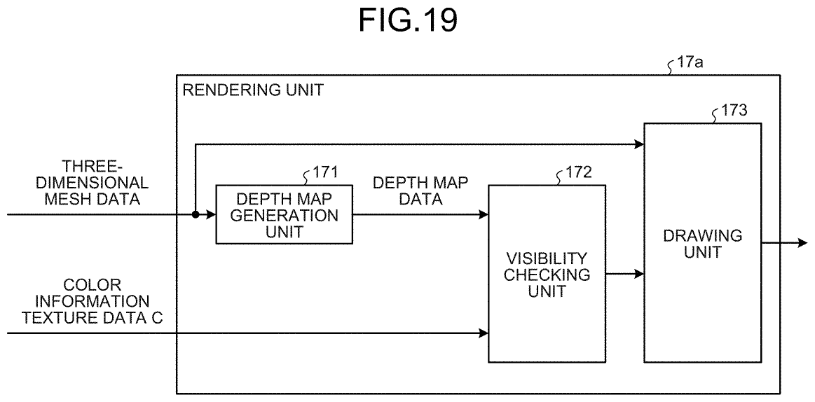

Next, a detailed configuration of the rendering unit 17a will be described with reference to FIG. 19. FIG. 19 is a functional block diagram illustrating an example of a functional configuration of the rendering unit.

As illustrated in FIG. 19, the rendering unit 17a includes a depth map generation unit 171, a visibility checking unit 172, and a drawing unit 173.

The depth map generation unit 171 generates the depth maps of the three-dimensional mesh data of the subject 90 generated by the triangular patch generation unit 163, viewed from the same projecting point Q from which the color information texture data C is viewed. In other words, the depth map generation unit 171 generates a plurality of depth maps respectively corresponding to the plurality of pieces of color information texture data C.

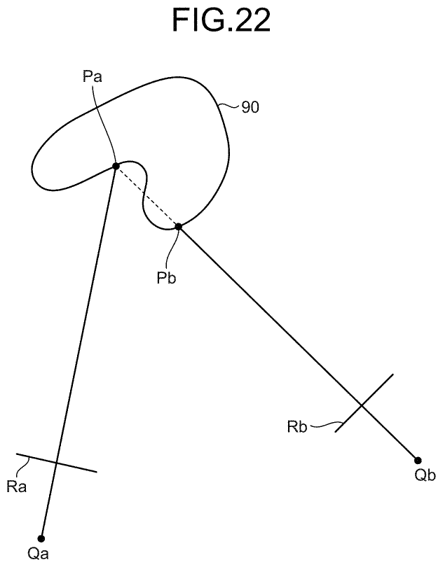

The visibility checking unit 172 compares each of the depth maps generated by the depth map generation unit 171 with the three-dimensional coordinates of the three-dimensional mesh data to perform visibility check that determines whether a three-dimensional mesh data of interest is visible from the projecting point Q. This determination determines a mesh cell that is invisible from the projecting point Q due to overlapping of a plurality of objects. Note that the visibility check will be described later in detail (see FIG. 22).

The drawing unit 173 draws a three-dimensional shape of a mesh that is determined to be visible (having visibility) by the visibility checking unit 172.

Furthermore, the drawing unit 173 maps the corresponding color information texture data C to the drawn mesh. This configuration makes it possible to generate an image of the subject 90, observed from any projecting point Q.

### [1-9. Modifications of First Embodiment]

Note that the first embodiment can be implemented in various modified forms. For example, in the tiling image T1 (see FIG. 9), the first-layer depth map Dm1, the second-layer depth map Dm2, and the color information texture data C do not necessarily need to be in one image. In other words, the first-layer depth map Dm1 and the second-layer depth map Dm2 may be collected in one image, and the color information texture data C may be in another image. Furthermore, the first-layer depth map Dm1, the second-layer depth map Dm2, and the color information texture data C may each be in one image (In this configuration, tiling does not need to be performed). Furthermore, all the pieces of color information texture data C may be in separated images (In this configuration, neither the packing processing nor the tiling processing need to be performed). Note that a plurality of images to be transmitted by the transmission unit 14 requires an increased number of image channels for the bit stream, but use of the mechanism of general multichannel streaming enables synchronization between the channels.

Furthermore, the transmission unit 14 may simultaneously transmit the tiling image T1 and voice information.

Furthermore, the tiling image T1 may be still image data or moving image data. In a case where the tiling image T1 is the still image data, the image compression processing unit 135 performs still image compression processing such as JPEG. Furthermore, in a case where the tiling image T1 is the moving image data, the image compression processing unit 135 performs moving image compression processing such as MPEG2, AVC, HEVC, VVC, or AV1.

Note that the tiling image T1 to be transmitted does not necessarily need to be compressed or decompressed. In this configuration, the image compression processing unit 135 (see FIG. 5) and the image decompression processing unit 161 (see FIG. 10) are unnecessary.

In addition, the depth value D1 stored in the first-layer depth map Dm1 and the depth value D2 stored in the second-layer depth map Dm2 may have any bit length. In other words, in addition to 8 bits described in the embodiment, 10 bits, 12 bits, or the like may be employed. Note that, the longer the bit lengths of the depth values D1 and D2 are, the finer the depth of the subject 90 can be expressed.

In addition, the tiling image T1 may be accumulated, as accumulated data, in the storage unit instead of transmission via the transmission unit 14 and the reception unit 15 so that the accumulated data may be read from the storage unit and reproduced.

Furthermore, the data acquisition unit 11 to the transmission unit 14 do not necessarily need to perform real-time processing operation. In other words, the tiling image T1 to be transmitted may be temporarily accumulated in the storage unit or the like, and the accumulated data may be read and transmitted to the decoding device 50a.

Note that the real time processing operation of the data acquisition unit 11 to transmission unit 14 can be used for real-time communication such as live streaming.

### [1-10. Effects of First Embodiment]

As described above, in an encoding device 40 (information processing device) of the first embodiment, the first-layer depth map generation unit 131 (distance acquisition unit) acquires the first distance d1 between the projecting point Q and the first point P1 at which the straight line extending from the projecting point Q to the subject 90 comes into contact with the subject 90, on the basis of the 3D shape of the surface of the subject 90. Furthermore, on the basis of the 3D shape of the surface of the subject 90, the second-layer depth map generation unit 132 (distance acquisition unit) acquires the second distance d2 between the projecting point Q and the second point P2 from which the straight line starting from the projecting point Q, as the start point, and extending through the inside of the subject 90 from the first point P1 passes to the outside of the subject 90.

This configuration makes it possible to simultaneously acquire the shapes of the front surface and the back surface of the subject 90 when the subject 90 is observed from the same position.

Furthermore, according to the encoding device 40 (information processing device) of the first embodiment, when the first point P1 is not positioned, the first-layer depth map generation unit 131 (distance acquisition unit) acquires the distance far (first distance value), as the first distance d1. Furthermore, when the second point P2 is not positioned, the second-layer depth map generation unit 132 (distance acquisition unit) acquires the distance near (second distance value) smaller than the distance far, as the second distance d2.

This configuration makes it possible to readily identify the area of the subject 90 and the area where the subject 90 is not positioned.

Furthermore, according to the encoding device 40 (information processing device) of the first embodiment, the first-layer depth map generation unit 131 (distance acquisition unit) and the second-layer depth map generation unit 132 (distance acquisition unit) set the distance far (first distance value) and the distance near (second distance value) to the equal values.

Accordingly, when the first-layer depth map Dm1 generated by the first-layer depth map generation unit 131 and the second-layer depth map Dm2 generated by the second-layer depth map generation unit 132 are arranged side by side, the boundary between the depth maps has no gap in depth value. Therefore, when the first-layer depth map Dm1 and the second-layer depth map Dm2 are arranged in one image and encoded, the compression efficiency of the image can be enhanced.

Furthermore, in the encoding device 40 (information processing device) of the first embodiment, the transmission unit 14 transmits the first distance d1 acquired by the first-layer depth map generation unit 131 and the second distance d2 acquired by the second-layer depth map generation unit 132 in association with each other, to the decoding device 50a that reconstructs the three-dimensional shape of the subject 90.

This configuration makes it possible to transmits the coordinates of the front surface side and the coordinates of the back surface side of the subject in association with each other. Therefore, transmission efficiency of the information can be improved.

Furthermore, the decoding device 50a (information processing device) of the first embodiment acquires the first distance d1 acquired by the first-layer depth map generation unit 131 and the second distance d2 acquired by the second-layer depth map generation unit 132, and identifies the area of the subject 90 on the basis of the magnitude relationship between the first distance d1 and the second distance d2.

This configuration makes it possible to identify the position range of the subject 90 only by simple comparison calculation.

Furthermore, in the decoding device 50a (information processing device) of the first embodiment, the triangular patch generation unit 163 (closed space generation unit) connects the front surface side end of the subject 90 as viewed from the projecting point Q and the back surface side end of the subject 90 as viewed from the projecting point Q. The front surface side end of the subject 90 is obtained on the basis of a plurality of the first distances d1 relating to the projecting point Q, and the back surface side end of the subject 90 is obtained on the basis of a plurality of the second distances d2 relating to the projecting point Q.

Therefore, the front surface and the back surface of the subject 90 are connected, generating the 3D model 90M of the subject 90 without the gap.

Furthermore, in the decoding device 50a (information processing device) of the first embodiment, in a case where the first distances d1 of two points (vertices B1 and C1) of the first distances d1 of adjacent three points (vertices A1, B1, and C1) of a triangular shape represents the front surface of the subject 90 and the first distance d1 of the remaining one point (vertex A1) does not represent the front surface of the subject 90, the triangular patch generation unit 163 (closed space generation unit) substitutes the remaining one point (vertex A1) for any one (any one of the vertices B2 and C2) of the two points, which represents the back surface of the subject 90, of the second distances d2 corresponding to the three points (vertices A1, B1, and C1), and substitutes one point (vertex A2), which does not represent the back surface of the subject 90, of the second distances d2 corresponding to the three points (vertices A1, B1, and C1) for one point (the vertex C2 if the remaining one point is substituted for the vertex B2, and the vertex B2 if the remaining one point is substitute for the vertex C2) that is the opposite point from the point for which the remaining one point (vertex A1) is substituted, of the two points (vertex B1 and C1) which represents the front surface of the subject 90.

Accordingly, the front surface and the back surface of the subject 90 can be connected without the gap by simple arithmetic processing.

### 2. Second Embodiment

### [2-1. Configuration of Tiling Image]

An information processing system 10b (not illustrated) of a second embodiment includes an encoding device 40b (not illustrated) instead of the encoding device 40a of the information processing system 10b (see FIG. 1) having been described in the first embodiment. Furthermore, a decoding device 50b (not illustrated) is provided instead of the decoding device 50a.

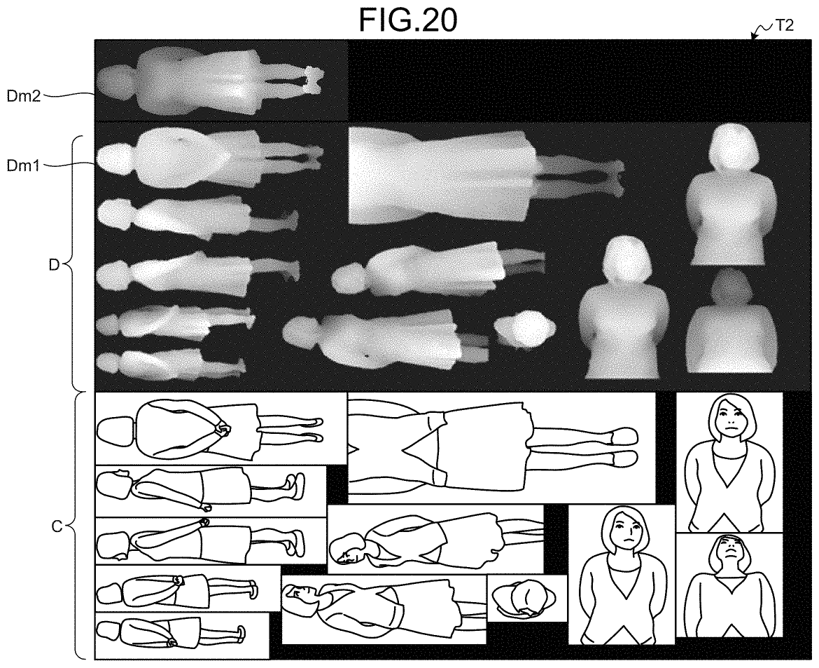

The encoding device 40b includes an encoding unit 13b and the transmission unit 14 which are not illustrated. Furthermore, the decoding device 50b includes the reception unit 15 and a decoding unit 16b (see FIG. 20).

Furthermore, the decoding device 50b includes a rendering unit 17b (see FIG. 20) instead of the rendering unit 17a.

Next, a function of the encoding unit 13b of the information processing system 10b will be described. The encoding unit 13b generates, for the plurality of pieces of color information texture data C, a plurality of first-layer depth maps D acquired from the same projecting points Q from which the respective pieces of color information texture data C are acquired. Note that the encoding unit 13b includes a tiling unit 134b (not illustrated) instead of the tiling unit 134a in the encoding unit 13a illustrated in FIG. 5.

FIG. 20 is a diagram illustrating an example of an image to be encoded that is generated by the tiling unit in the second embodiment.

A tiling image T2 illustrated in FIG. 20 is different from the tiling image T1 (see FIG. 9) described in the first embodiment in that the tiling image T2 includes the plurality of first-layer depth maps D corresponding to the plurality of pieces of color information texture data C on a one-to-one basis. In other words, the tiling unit 134b generates the tiling image T2 in which the plurality of pieces of color information texture data C about the subject 90 as viewed from a plurality of projecting points Q and the first-layer depth maps D as viewed from the plurality of projecting points Q that is the same as the projecting points from which the plurality of pieces of color information texture data C is acquired are associated with each other. Note that the first-layer depth map Dm1 described in the first embodiment is included in the plurality of first-layer depth maps D that is arranged in the tiling image T2 as illustrated in FIG. 20. The tiling image T2 also includes the second-layer depth map Dm2 described in the first embodiment. The tiling unit 134b is an example of a color/distance acquisition unit in the present disclosure.

The plurality of first-layer depth maps D included in the tiling image T2 are used for visibility check (see FIG. 22) which is described later when the decoding unit 16b reconstructs the three-dimensional shape of the subject 90.

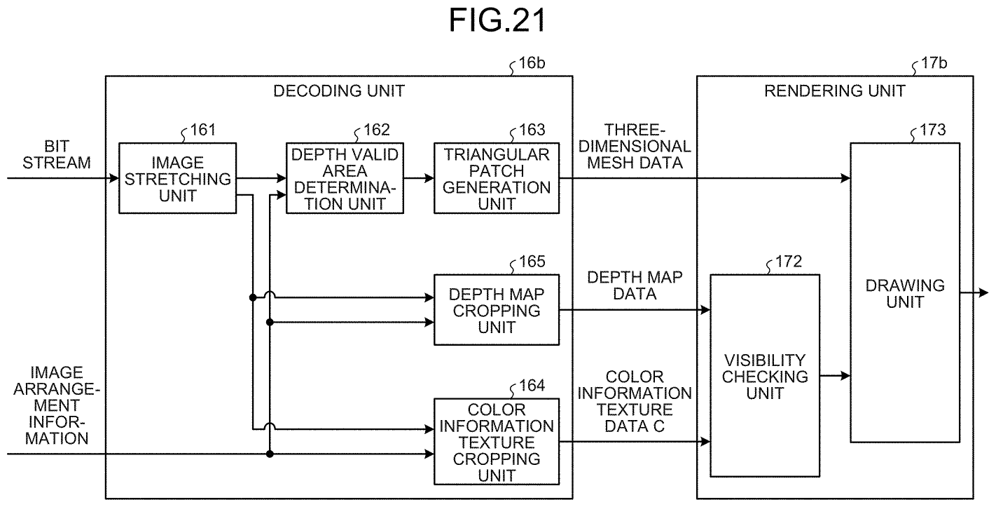

Next, functions of the decoding unit 16b and the rendering unit 17b of the information processing system 10b will be described with reference to FIG. 21. FIG. 21 is a functional block diagram illustrating an example of a functional configuration of the decoding unit and the rendering unit of the second embodiment.

The decoding unit 16b has a configuration that includes a depth map cropping unit 165 in addition to the decoding unit 16a (see FIG. 10) described in the first embodiment. The depth map cropping unit 165 crops out an area of the subject 90 from the plurality of pieces of color information texture data C, on the basis of the first-layer depth maps D corresponding to the respective pieces of color information texture data C. More specifically, when a valid depth value is stored in any of the first-layer depth maps D, the color information texture data C corresponding to coordinates at which the depth value is stored is determined as the area of the subject 90 and cropped out.

The rendering unit 17b has a configuration that does not include the depth map generation unit 171, as compared with that of the rendering unit 17a (see FIG. 19) described in the first embodiment.

Although in the information processing system 10a, the generation of the depth map is performed for the visibility cheek by the rendering unit 17a in the information processing system 10b, the generation of the depth map is performed by the decoding unit 16b. Furthermore, the decoding unit 16b does not actually create the depth maps, but only performs acquisition of the plurality of first-layer depth maps D generated by the encoding unit 13b. Then, the depth map cropping unit 165 of the decoding unit 16b uses the first-layer depth maps D to crop out the color information texture data C corresponding to the area of the subject 90.

Therefore, it is possible to reduce processing having a high calculation load, that is, generation of the depth maps.

### [2-2. Visibility Check]

Next, the visibility check will be described with reference to FIG. 22. FIG. 22 is a diagram illustrating the visibility check.

In a case where images of the subject 90 as viewed from a plurality of different projecting points Q are generated, it is necessary to determine whether a point on the front surface of the subject 90 is visible from each projecting point Q. In other words, the color information texture data C recorded on the projection plane R (u, v) is a surface closest to the projecting point Q, and a surface on the back side that is shielded by the surface is invisible from the projecting point Q.

Specifically, in FIG. 22, a point Pa (an example of a first point) on the subject 90 is visualized from a projecting point Qa, and the depth value (first distance) of the point Pa is recorded on the projection plane Ra. Meanwhile, when the point Pa is observed from a different projecting point Qb, the point Pa is shielded by a point Pb on the front side and cannot be visualized. The depth value (a distance different from the first distance) of the point Pb is stored in the projection plane Rb.

Therefore, in FIG. 22, the three-dimensional coordinates of the point Pa calculated from the depth value stored in the projection plane Ra do not match the three-dimensional coordinates of the point Pb calculated from the depth value stored in the projection plane Rb. In other words, when the three-dimensional position of the point Pa according to the depth value as viewed from the projecting point Qa does not match the three-dimensional position according to the depth value corresponding to a direction toward the point Pa viewed from the projecting point Qb different from the projecting point Qa, the visibility checking unit 172 determines that the point Pa viewed from the projecting point Qa is not visible from the projecting point Qb different from the projecting point Qa.

Then, when drawing the image of the subject 90 as viewed from the projecting point Qb, the drawing unit 173 does not use the color information texture data C at the point Pb, but uses the color information texture data C projected to a projecting point that is closer to the projecting point Qb and that is determined to visualize the point Pa. In addition, the color information texture data C projected to a plurality of projecting points that is closer to the projecting point Qb and that visualizes the point Pa may be mixed and used.

### [2-3. Effects of Second Embodiment]

As described above, in the encoding device 40b (information processing device) of the second embodiment, the tiling unit 134b (color/distance acquisition unit) acquires the color information texture data C (texture information) about the subject 90 as viewed from the plurality of projecting points Q and the first distances d1 as viewed from the plurality of projecting points Q that is the same as the projecting points from which the color information texture data C is acquired, in association with each other.

This configuration makes it possible to provide one of the first-layer depth maps D being the first-layer depth map Dm1 paired with the second-layer depth map Dm2. Therefore, the amount of data transmitted by the transmission uni: 14 can be reduced.

Furthermore, in the decoding device 50b (information processing device) of the second embodiment, the visibility checking unit 172 determines, based on the information acquired by the tiling unit 134b (color/distance acquisition unit), that the point Pa viewed from the projecting point Qa is not visible from the projecting point Qb, when the three-dimensional position of the point Pa according to the first distance d1 as viewed from the projecting point Qa does not match the three-dimensional position according to the first distance d1 corresponding to the direction toward the point Pa as viewed from the projecting point Qb different from the projecting point Qa.

Thus, visibility cheek can be performed by simple processing using the tiling image T2.

### 3. Third Embodiment

### [3-1. Function of Third Embodiment]

In the first embodiment and the second embodiment, in a case where the subject 90 has a complex shape, it is difficult to continuously convert the 3D shape of the surface of the subject 90 into data due to occurrence of occlusion. In order to solve such a problem, the information processing system 10b according to a third embodiment decomposes the subject 90 into a plurality of objects, generates a plurality of first-layer depth maps Dm1 and second-layer depth maps Dm2 from the same projecting point Q for the objects after decomposing, thereby continuously converting the surface of the subject 90 into data.

Note that the configuration (hardware configuration and functional configuration) of the information processing system 10b according to the third embodiment is the same as that of the information processing system 10b (the encoding device 40b and the decoding device 50b) described in the second embodiment, and thus description thereof is omitted.

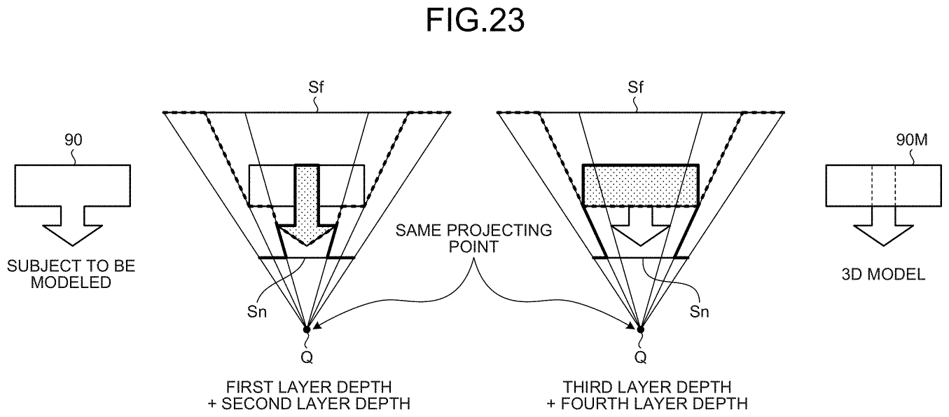

Next, the function of the information processing system according to the third embodiment will be described with reference to FIG. 23. FIG. 23 is a diagram illustrating the function of the information processing system according to the third embodiment.

In the encoding device 40b included in the information processing system 10b, the 3D model generation unit 12 decomposes the subject 90 into the plurality of objects. Then, the first-layer depth map generation unit 131 and the second-layer depth map generation unit 132 generate a plurality of first-layer depth maps Dm1 and second-layer depth maps Dm2 viewed from the same projecting point Q for the objects after decomposing. In other words, the first-layer depth map generation unit 131 and the second-layer depth map generation unit 132 acquire the first distances d1 and the second distances d2 viewed from the same projecting point Q for the objects into which the subject 90 is decomposed. As described in the first embodiment, when the straight line extending from the projecting point Q as the start point to the subject 90 passes through the subject 90 a plurality of times, each time the straight line passes through the subject 90, the pair of the first and second points P1 and P2 is generated.

For example, as illustrated in FIG. 23, the 3D model generation unit 12 decomposes the subject 90 to be modeled into a first object of arrow shape and a second object of rectangular shape. Then, the first-layer depth map generation unit 131 and the second-layer depth map generation unit 132 generate the first-layer depth map Dm1 and the second-layer depth map Dm2 of the first object as viewed from the projecting point Q.

However, since the information processing system 10b needs to reconstruct a video of the subject 90 viewed from the projecting point Q (view dependent rendering), the first-layer depth map Dm1 is a depth map of the entire subject 90 viewed from the projecting point Q.

In other words, the first-layer depth map generation unit 131 generates the first-layer depth map Dm1 storing depth values indicated by the dotted lines illustrated in FIG. 23, for the subject 90. Then, the second-layer depth map generation unit 132 generates, for the first object of arrow shape, the second-layer depth map Dm2 storing depth values indicated by the thick line representing the depth values on the back surface side of the first object. The first-layer depth map Dm1 and the second-layer depth map Dm2 are paired and used for reconstruction of the subject 90.

Next, the first-layer depth map generation unit 131 generates the first-layer depth map Dm1 of the second object of rectangular shape viewed from the projecting point Q. Note that the first-layer depth map Dm1 generated here is referred to as a third layer depth map for distinction from the first-layer depth map Dm1 described above.

Then, the second-layer depth map generation unit 132 generates the second-layer depth map Dm2 of the second object viewed from the projecting point Q. Note that the second-layer depth map Dm2 generated here is referred to as a fourth layer depth map for distinction from the second-layer depth map Dm2 described above. The third layer depth map and the fourth layer depth map generated in this manner are paired and used for reconstruction of the subject 90.

The rendering unit 17b uses the pairs of the depth maps of the objects into which the subject 90 is decomposed to perform rendering of the objects by the method described above. Then, the objects are combined, with the closest point when the rendered objects are observed from the projecting point, as the front surface of the subject 90, thereby continuously reconstructing the surface of the subject 90.

Note that, in a case where the subject 90 has a more complex shape, the subject 90 may be decomposed into more objects so that processing the same as the processing described above tray be repeated to generate more pairs of depth maps.

### [3-2. Effects of Third Embodiment]

As described above, in the encoding device 40b (information processing device) of the third embodiment, the first-layer depth map generation unit 131 and the second-layer depth map generation unit 132 (distance acquisition units) acquire the first distances d1 and the second distances d2 from the same projecting point Q, for the objects into which the subject 90 is decomposed. Then, the respective objects reconstructed on the basis of the first distances d1 and the second distances d2 are combined to reconstruct the image of the subject 90.

This configuration makes it possible to continuously reconstruct the image of the subject 90, even when the subject 90 has a complex shape.

### 4. Fourth Embodiment

### [4-1. Function of Fourth Embodiment]

In the first embodiment and the second embodiment, in a case where the subject 90 has a complex shape, it is difficult to continuously convert the 3D shape of the surface of the subject 90 into data due to occurrence of occlusion. In order to solve such a problem, the information processing system 10b according to a fourth embodiment decomposes the subject 90 into the plurality of objects, generates the first-layer depth maps Dm1 and the second-layer depth maps Dm2 for the objects after decomposing, from a plurality of projecting points, thereby continuously converting the surface of the subject 90 into data.

Note that the configuration (hardware configuration and functional configuration) of the information processing system 10b according to the fourth embodiment is the same as that of the information processing system 10b (the encoding device 40b and the decoding device 50b) described in the second embodiment, and thus description thereof is omitted.

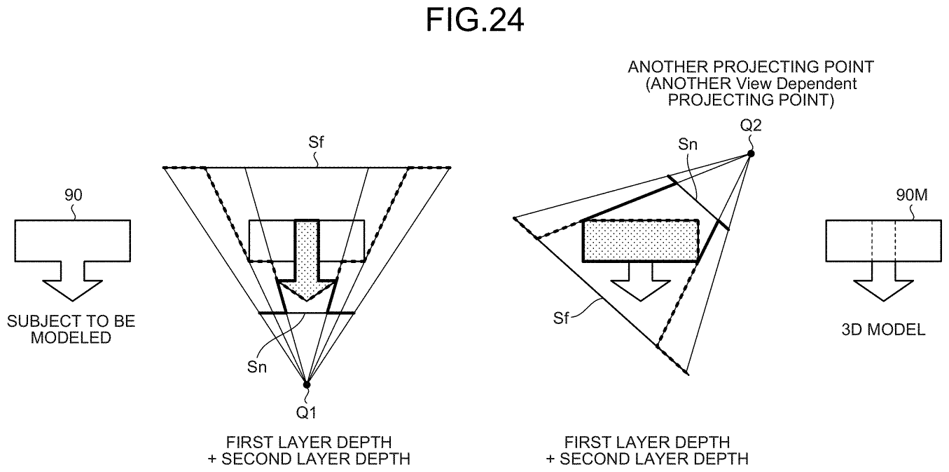

Next, the function of the information processing system according to the fourth embodiment will be described with reference to FIG. 24. FIG. 24 is a diagram illustrating the function of the information processing system according to the fourth embodiment.

In the encoding device 40b included in the information processing system 10b, the 3D model generation unit 12 decomposes the subject 90 into the plurality of objects. Then, the first-layer depth map generation unit 131 and the second-layer depth map generation unit 132 generate the first-layer depth maps Dm1 and second-layer depth maps Dm2 viewed from different projecting points Q1, Q2, . . . for the objects after decomposing. In other words, the first distances d1 and the second distances d2 viewed from the different projecting points Q1, Q2, . . . are acquired for the objects into which the subject 90 is decomposed. As described in the first embodiment, when the straight line extending from the projecting point Q as the start point to the subject 90 passes through the subject 90 a plurality of times, each time the straight line passes through the subject 90, the pair of the first and second points P1 and P2 is generated.

For example, as illustrated in FIG. 24, the 3D model generation unit 12 decomposes the subject 90 to be modeled into the first object of arrow shape and the second object of rectangular shape. Then, the first-layer depth map generation unit 131 and the second-layer depth map generation unit 132 generate the first-layer depth map Dm1 and the second-layer depth map Dm2 of the first object as viewed from the projecting point Q1. In addition, the first-layer depth map generation unit 131 and the second-layer depth map generation unit 132 generate the first-layer depth map Dm1 and the second-layer depth map Dm2 of the first object as viewed from the projecting point Q2.

However, since the information processing system 10b needs to reconstruct videos of the subject 90 viewed from the projecting points Q1 and Q2 (view dependent rendering), the first-layer depth maps Dm1 are depth maps of the entire subject 90 viewed from the projecting points Q1 and Q2.

In other words, the first-layer depth map generation unit 131 generates the first-layer depth map Dm1 of the entire subject 90 viewed from the projecting point Q1. Therefore, the first-layer depth map Dm1 storing the depth values indicated by the dotted lines illustrated in FIG. 24 is generated. Then, the second-layer depth map generation unit 132 generates the second-layer depth map Dm2 storing the depth values indicated by the thick line representing the depth values on the back surface side of the first object of arrow shape. The first-layer depth map Dm1 and the second-layer depth map Dm2 are paired and used for reconstruction of the subject 90.

Next, the first-layer depth map generation unit 131 generates the first-layer depth map Dm1 of the entire subject 90 viewed from the projecting point Q2. Therefore, the first-layer depth map Dm1 storing the depth values indicated by the dotted lines illustrated in FIG. 24 is generated. Then, the second-layer depth map generation unit 132 generates the second-layer depth map Dm2 storing the depth values indicated by the thick line representing the depth values on the back surface side of the second object of rectangular shape. The first-layer depth map Dm1 and the second-layer depth map Dm2 are paired and used for reconstruction of the subject 90.

### [4-2. Effects of Fourth Embodiment]

As described above, in the encoding device 40b (information processing device) of the fourth embodiment, the first-layer depth map generation unit 131 and the second-layer depth map generation unit 132 (distance acquisition units) acquire the first distances d1 and the second distances d2 from the different projecting points Q1 and Q2, for the objects into which the subject 90 is decomposed. Then, the respective objects reconstructed on the basis of the first distances d1 and the second distances d2 are combined to reconstruct the image of the subject 90.

This configuration makes it possible to continuously reconstruct the image of the subject 90, even when the subject 90 has a complex shape.

### 5. Application Example of Present Disclosure

### [5-1. Production of Content]

For example, the 3D model 90M of the subject 90 generated by the 3D model generation unit 12 and the 3D model managed by another server may be combined to produce video content. Furthermore, for example, when background data is stored in an imaging device such as Lidar, combining the 3D model 90M of the subject 90 generated by the 3D model generation unit 12 with the background data makes it possible to create content in which the subject 90 appears to be positioned at a place indicated by the background data.

### [5-2. Experience in Virtual Space]

For example, the subject 90 generated by the 3D model generation unit 12 can be arranged in a virtual space that is a space where the users perform communication using avatars. In this configuration, the users can view the subject 90 in live action using the avatars.

[5-3. Application to Communication with Remote Location]

For example, transmission of the 3D model 90M of the subject 90 generated by the 3D model generation unit 12 from the transmission unit 14 to a remote location makes it possible for a user at the remote location to view the 3D model 90M of the subject 90 through a reproduction device at the remote location. For example, transmission of the 3D model 90M of the subject 90 in real time makes it possible for the subject 90 and the user at the remote location to communicate with each other in real time. For example, it can be assumed that the subject 90 is a teacher and the user is a student, or that the subject 90 is a doctor and the user is a patient, and the like.

### [5-4. Others]

For example, it is also possible to generate a free-viewpoint video of sports or the like on the basis of the 3D models 90M of a plurality of subjects 90 generated by the 3D model generation unit 12. Furthermore, an individual person can distribute himself/herself generated by the 3D model generation unit 12 to a distribution platform. As described above, the contents in the embodiments described in the present description are applicable to various technologies and services.

Although the present disclosure has been described in accordance with several embodiments, these embodiments may be implemented by any device. The device preferably has a necessary functional block to obtain necessary information.

Furthermore, for example, the respective steps of one flowchart may be performed by one device, or may be shared between and performed by a plurality of devices. Furthermore, when a plurality of processes is included in one step, the plurality of processes may be performed by one device, or may be shared between and performed by a plurality of devices. In other words, a plurality of processes included in one step can also be performed as a process including a plurality of steps. Conversely, a process described as a plurality of steps can be collectively performed as one step.

Furthermore, for example, the program executed by the computer may execute the processing steps of the program, in chronological order along description in the present description, or may execute the processing steps in parallel or individually at necessary timing such as calling. In other words, the processing of the respective steps may be executed in an order different from the above-described order within a consistent range. Furthermore, the processing steps of the program may be executed in parallel with or in combination with the processing of another program.

Furthermore, for example, a plurality of technologies related to the present technology can be implemented independently within a consistent range. As a matter of course, a plurality of arbitrary present technologies may be implemented in combination with each other. For example, the present technology described in any of the embodiments may be implemented in combination with the present technology described in another embodiment. Furthermore, any of the present technologies described above nay be implemented in combination with another technologies not described above.

It should be noted that the effects described herein are merely examples, and the present invention is not limited to these effects and may have other effects.

The embodiments of the present disclosure is not limited to the embodiments described above, and various modifications and alterations can be made without departing from the spirit and scope of the present disclosure.

Note that the present disclosure can also have the following configurations.

(1)

An information processing device including:
a distance acquisition unit that acquires, based on a 3D shape of a surface of a subject, a first distance between a projecting point and a first point at which a straight line extending from the projecting point to the subject comes into contact with the subject, and a second distance between the projecting point and a second point from which the straight line extending through the inside of the subject from the first point passes to the outside of the subject.
   (2)

The information processing device according to (1), wherein
the distance acquisition unit
acquires a predetermined first distance value as the first distance, when the first point is not positioned, and
acquires a predetermined second distance value that is smaller than the first distance value, as the second distance, when the second point is not positioned.
   (3)

The information processing device according to (2),
the distance acquisition unit
sets the first distance value and the second distance value to equal values.
   (4)

The information processing device according to any one of (1) to (3), further including
a transmission unit that transmits the first distance and the second distance acquired by the distance acquisition unit in association with each other, to a decoding device reconstructing a three-dimensional shape of the subject.
   (5)

The information processing device according to any one of (1) to (4), further including
a color/distance acquisition unit that acquires texture information about the subject as viewed from a plurality of projecting points and the first distance as viewed from the plurality of projecting points that is the same as the projecting points from which the texture information is acquired, in association with each other.
   (6)

The information processing device according to any one of (1) to (5), wherein
the distance acquisition unit acquires the first distance and the second distance from the same projecting point, for objects into which the subject is decomposed.
   (7)

The information processing device according to any one of (1) to (5), wherein
the distance acquisition unit acquires the first distance and the second distance from the projecting points different from each other, for objects into which the subject is decomposed.
   (8)

An information processing device including
an area determination unit that
acquires, based on a 3D shape of a surface of a subject, a first distance between a projecting point and a first point at which a straight line extending from the projecting point to the subject comes into contact with the subject, or a predetermined first distance value as the first distance when the first point is not positioned,
acquires a second distance between the projecting point and a second point from which the straight line extending through the inside of the subject from the first point passes to the outside of the subject, or a predetermined second distance value that is smaller than the first distance value, as the second distance, when the second point is not positioned, and
identifies an area of the subject based on a magnitude relationship between the first distance and the second distance.
   (9)

The information processing device according to (8), further including
a closed space generation unit that connects a front surface side end of the subject as viewed from the projecting point, based on a plurality of the first distances relating to the projecting point and a back surface side end of the subject as viewed from the projecting point, based on a plurality of the second distances relating to the projecting point.
   (10)

The information processing device according to (9), wherein
the closed space generation unit
when the first distances of two points of the first distances of adjacent three points of a triangular shape represents a front surface of the subject and the first distance of remaining one point does not represent the front surface of the subject,
substitutes the remaining one point for any one of the two points, which represents a back surface of the subject, of the second distances corresponding to the three points, and
substitutes one point that does not represent the back surface of the subject, of the second distances corresponding to the three points for one point that is an opposite point from the point for which the remaining one point is substituted, of the two points that represents the front surface of the subject.
   (11)

The information processing device according to (8), further including:
a color/distance acquisition unit that acquires texture information about the subject as viewed from a plurality of projecting points and the first distance as viewed from the plurality of projecting points that is the same as the projecting points from which the texture information is acquired, in association with each other; and
a visibility checking unit that determines, based on the information acquired by the color/distance acquisition unit, that a first point viewed from the projecting point is not visible from a projecting point different from the projecting point, when a three-dimensional position of the first point according to the first distance as viewed from the projecting point does not match a three-dimensional position according to the first distance corresponding to a direction toward the first point as viewed from a projecting point different from the projecting point.
   (12)

A method of generating a 3D model including
acquiring, based on a 3D shape of a surface of a subject, a first distance between a projecting point and a first point at which a straight line extending from the projecting point to the subject comes into contact with the subject, and a second distance between the projecting point and a second point from which the straight line extending through the inside of the subject from the first point passes to the outside of the subject, associating a position of the projecting point, the first distance, and the second distance with each other, and generating a 3D model of the subject.
   (13)

A program for causing
a computer to function as
a distance acquisition unit that acquires, based on a 3D shape of a surface of a subject, a first distance between a projecting point and a first point at which a straight line extending from the projecting point to the subject comes into contact with the subject, and a second distance between the projecting point and a second point from which the straight line extending through the inside of the subject from the first point passes to the outside of the subject.

### REFERENCE SIGNS LIST

10a, 10b INFORMATION PROCESSING SYSTEM

11 DATA ACQUISITION UNIT

12 3D MODEL GENERATION UNIT

13a, 13b ENCODING UNIT

14 TRANSMISSION UNIT

15 RECEPTION UNIT

16a, 16b DECODING UNIT

17a, 17b RENDERING UNIT

18 DISPLAY UNIT

40a, 40b ENCODING DEVICE (INFORMATION PROCESSING DEVICE)

50a, 50b DECODING DEVICE (INFORMATION PROCESSING DEVICE)

70(70a, 70b, 70c, 70d, 70e) IMAGING DEVICE

90 SUBJECT

90M 3D MODEL

131 FIRST-LAYER DEPTH MAP GENERATION UNIT (DISTANCE ACQUISITION UNIT)

132 SECOND-LAYER DEPTH MAP GENERATION UNIT (DISTANCE ACQUISITION UNIT)

133 COLOR INFORMATION PACKING UNIT

134a, 134b TILING UNIT (COLOR/DISTANCE ACQUISITION UNIT)

135 IMAGE COMPRESSION PROCESSING UNIT

161 IMAGE DECOMPRESSION PROCESSING UNIT

162 DEPTH VALID AREA DETERMINATION UNIT (AREA DETERMINATION UNIT)

163 TRIANGULAR PATCH GENERATION UNIT (CLOSED SPACE GENERATION UNIT)

164 COLOR INFORMATION TEXTURE CROPPING UNIT

165 DEPTH MAP CROPPING UNIT

171 DEPTH MAP GENERATION UNIT

172 VISIBILITY CHECKING UNIT

173 DRAWING UNIT

C COLOR INFORMATION TEXTURE DATA (TEXTURE INFORMATION)

D1, D2 QUANTIZED DEPTH VALUE (DEPTH VALUE)

Dm1, D FIRST-LAYER DEPTH MAP

Dm2 SECOND-LAYER DEPTH MAP

d1 FIRST DISTANCE

d2 SECOND DISTANCE

N NUMBER OF VALID POINTS

P1 FIRST POINT

P2 SECOND POINT

Q, Q1, Q2, Ca, Qb PROJECTING POINT

R, Ra, Rb PROJECTION PLANE

T1, T2 TILING IMAGE

far DISTANCE (FIRST DISTANCE VALUE)

near DISTANCE (SECOND DISTANCE VALUE)

1. An information processing device including:
a distance acquisition unit that acquires, based on a 3D shape of a surface of a subject, a first distance between a projecting point and a first point at which a straight line extending from the projecting point to the subject comes into contact with the subject, and a second distance between the projecting point and a second point from which the straight line extending through the inside of the subject from the first point passes to the outside of the subject.

2. The information processing device according to claim 1, wherein
the distance acquisition unit
acquires a predetermined first distance value as the first distance, when the first point is not positioned, and
acquires a predetermined second distance value that is smaller than the first distance value, as the second distance, when the second point is not positioned.

3. The information processing device according to claim 2,
the distance acquisition unit
sets the first distance value and the second distance value to equal values.

4. The information processing device according to claim 1, further including
a transmission unit that transmits the first distance and the second distance acquired by the distance acquisition unit in association with each other, to a decoding device reconstructing a three-dimensional shape of the subject.

5. The information processing device according to claim 1, further including
a color/distance acquisition unit that acquires texture information about the subject as viewed from a plurality of projecting points and the first distance as viewed from the plurality of projecting points that is the same as the projecting points from which the texture information is acquired, in association with each other.

6. The information processing device according to claim 1, wherein
the distance acquisition unit acquires the first distance and the second distance from the same projecting point, for objects into which the subject is decomposed.

7. The information processing device according to claim 1, wherein
the distance acquisition unit acquires the first distance and the second distance from the projecting points different from each other, for objects into which the subject is decomposed.

8. An information processing device including
an area determination unit that
acquires, based on a 3D shape of a surface of a subject, a first distance between a projecting point and a first point at which a straight line extending from the projecting point to the subject comes into contact with the subject, or a predetermined first distance value as the first distance when the first point is not positioned,
acquires a second distance between the projecting point and a second point from which the straight line extending through the inside of the subject from the first point passes to the outside of the subject, or a predetermined second distance value that is smaller than the first distance value, as the second distance, when the second point is not positioned, and
identifies an area of the subject based on a magnitude relationship between the first distance and the second distance.

9. The information processing device according to claim 8, further including
a closed space generation unit that connects a front surface side end of the subject as viewed from the projecting point, based on a plurality of the first distances relating to the projecting point and a back surface side end of the subject as viewed from the projecting point, based on a plurality of the second distances relating to the projecting point.

10. The information processing device according to claim 9, wherein
the closed space generation unit
when the first distances of two points of the first distances of adjacent three points of a triangular shape represents a front surface of the subject and the first distance of remaining one point does not represent the front surface of the subject,
substitutes the remaining one point for any one of the two points, which represents a back surface of the subject, of the second distances corresponding to the three points, and
substitutes one point that does not represent the back surface of the subject, of the second distances corresponding to the three points for one point that is an opposite point from the point for which the remaining one point is substituted, of the two points that represents the front surface of the subject.

11. The information processing device according to claim 8, further including:
a color/distance acquisition unit that acquires texture information about the subject as viewed from a plurality of projecting points and the first distance as viewed from the plurality of projecting points that is the same as the projecting points from which the texture information is acquired, in association with each other; and
a visibility checking unit that determines, based on the information acquired by the color/distance acquisition unit, that a first point viewed from the projecting point is not visible from a projecting point different from the projecting point, when a three-dimensional position of the first point according to the first distance as viewed from the projecting point does not match a three-dimensional position according to the first distance corresponding to a direction toward the first point as viewed from a projecting point different from the projecting point.

12. A method of generating a 3D model including
acquiring, based on a 3D shape of a surface of a subject, a first distance between a projecting point and a first point at which a straight line extending from the projecting point to the subject comes into contact with the subject, and a second distance between the projecting point and a second point from which the straight line extending through the inside of the subject from the first point passes to the outside of the subject, associating a position of the projecting point, the first distance, and the second distance with each other, and generating a 3D model of the subject.

13. A program for causing
a computer to function as
a distance acquisition unit that acquires, based on a 3D shape of a surface of a subject, a first distance between a projecting point and a first point at which a straight line extending from the projecting point to the subject comes into contact with the subject, and a second distance between the projecting point and a second point from which the straight line extending through the inside of the subject from the first point passes to the outside of the subject.
